(19) United States
(12) Patent Application Publication
(10) Pub. No.: US 2026/0321220 A1
(43) Pub. Date: Oct. 15, 2026

(54) DISPLAY APPARATUS, ANALYSIS APPARATUS FOR THE DISPLAY APPRATUS, AND CONTROL METHOD OF THE ANALYSIS DEVICE

(71) Applicant: SAMSUNG ELECTRONICS CO., LTD., Suwon-si (KR)

(72) Inventors: Min HEO, Suwon-si (KR); Yonghun SON, Suwon-si (KR); Sangwoo KIM, Suwon-si (KR); Sangwoo PARK, Suwon-si (KR); Kyunghee JUNG, Suwon-si (KR)

(73) Assignee: SAMSUNG ELECTRONICS CO., LTD., Suwon-si (KR)

(21) Appl. No.: 19/465,141

(22) Filed: Jan. 30, 2026

Related U.S. Application Data
(63) Continuation of application No. PCT/KR2025/020574, filed on Dec. 3, 2025.

(30) Foreign Application Priority Data
Dec. 23, 2024 (KR) 10-2024-0194733

(51) Int. Cl. G09G 3/36; G06T 7/00

(52) U.S. Cl. CPC G09G 3/3607; G06T 7/0002; G06T 2207/30168; G09G 2320/0252; G09G 2320/0626; G09G 2360/16

(57) ABSTRACT

An analysis apparatus may include: a communication device configured to communicate with a display apparatus; a sensor configured to obtain an image displayed on the display apparatus; and a controller configured to: based on a first and second image obtained by the sensor, the first and second image respectively including a first and second plurality of gray values where the second plurality of gray values respectively correspond to, and are different values from, the first plurality of gray values, recognize a plurality of response times respectively corresponding to a time to change from the first to the second plurality of gray values, based on a difference between the response times and a reference response time, identify information corresponding to a modification to an overdrive table of the display apparatus, and control the communication device to transmit the identified information to the display apparatus such that the overdrive table is correctable.

### CROSS-REFERENCE TO RELATED APPLICATIONS

This is a continuation application, under 35 U.S.C. § 111(a), of International Application No. PCT/KR2025/020574, filed Dec. 3, 2025, which claims priority under 35 U.S.C. § 119 to Korean Patent Application No. 10-2024-0194733, filed Dec. 23, 2024, in the Korean Intellectual Property Office, the disclosures of which are incorporated herein in their entireties by reference.

### TECHNICAL FIELD

The present disclosure relates to a display apparatus for optimizing a response speed, an analysis apparatus for the display apparatus, and a control method of the analysis apparatus.

### BACKGROUND ART

A display apparatus is an apparatus that displays visual and three-dimensional image information, and includes a liquid crystal display device (LCD), an electroluminescence display device (ELD), a field emission display device (FED), a plasma display panel (hereinafter, referred to as “PDP”), a thin film liquid crystal display (TFT-LCD), a flexible display device, etc.

The liquid crystal display device is one of flat panel display devices that are currently most widely used, and includes two substrates with electrodes between two glass plates attached with a sealant, and liquid crystals provided between the two substrates.

The liquid crystal display device displays images by applying a voltage to the electrodes provided on the two substrates to generate an electric field and determining the orientation of liquid crystal molecules through the electric field to control the polarization of incident light.

The liquid crystal display device requires a short response time of the liquid crystals to improve the image quality of output images.

Recently, overdrive technologies are used to shorten the response time of the liquid crystals in the liquid crystal display device.

The overdrive technologies accelerate the state transition of brightness by causing a voltage applied to the electrodes to be higher or lower than the target voltage, and these technologies may shorten the response time in gray scale.

However, the overdrive technologies have a problem of causing at least one of afterimages, reverse afterimages, or color fringing in images. Accordingly, there is a need for overdrive technologies capable of preventing afterimages, reverse afterimages, or color fringing in images while satisfying a response time within a reference response time range.

### DISCLOSURE

### Technical Problem

An aspect of the present disclosure provides a display apparatus for correcting an overdrive table based on at least one of a response speed of liquid crystals or image quality information of an image, an analysis apparatus for the display apparatus, and a control method of the analysis apparatus.

Another aspect of the present disclosure provides a display apparatus for correcting an overdrive table based on image quality information of the display apparatus obtained by a user device, an analysis apparatus for the display apparatus, and a control method of the analysis apparatus.

### Technical Solution

In accordance with the present disclosure, an analysis apparatus may include: a communication device configured to communicate with a display apparatus; a sensor configured to obtain a an image of a test image displayed on the display apparatus; and a controller configured to: based on a first image of a first test image obtained by the sensor and a second image of a second test image obtained by the sensor, the first image including a first plurality of gray values displayed on the display apparatus and the second image including a second plurality of gray values displayed on the display apparatus that respectively correspond to, and are different values from, the first plurality of gray values, recognize a plurality of response times respectively corresponding to a time for the first plurality of gray values to change to the second plurality of gray values, based on a difference between the recognized plurality of response times and a reference response time, identify information corresponding to a modification to an overdrive table of the display apparatus, and control the communication device to transmit the identified information to the display apparatus such that the overdrive table of the display apparatus is correctable based on the identified information.

The controller may be further configured to: recognize identification information of the display apparatus, recognize an original overdrive table of the display apparatus based on the identification information of the display apparatus, and apply the information corresponding to a modification to correct the original overdrive table.

The controller may be further configured to: recognize at least one response time among the recognized plurality of response times that exceeds the reference response time, recognize a first gray value among the first plurality of gray values and a second gray value among the second plurality of gray values which respectively correspond to the recognized at least one response time, recognize a setting voltage of the original overdrive table that corresponds to the first gray value and the second gray value, and based on to the first gray value being smaller than the second gray value, increase the recognized setting voltage by a first voltage to correct the original overdrive table, or based on the first gray value being greater than the second gray value, decrease the recognized setting voltage by a second voltage to correct the original overdrive table.

The analysis apparatus may further include an input device, wherein the controller may be further configured to receive the reference response time from the input device.

The controller may be further configured to: recognize an average response time of the recognized plurality of response times, and recognize the reference response time based on the recognized average response time.

The sensor may be a first sensor, the identified information correspond to the modification to the overdrive table of the display apparatus may be identified first information, and the analysis apparatus may further include a second sensor configured to obtain an image of a test image displayed on the display apparatus, wherein the controller may be further configured to: based on the recognized plurality of response times being shorter than the reference response time, control the communication device to transmit the identified first information to the display apparatus such that a primary correction of the overdrive table of the display apparatus is performed based on the identified first information, based on a third image of a third test image displayed on the display apparatus obtained by the second sensor, recognize an image quality of the third image, based on the recognized image quality, identify second information corresponding to a modification to the overdrive table that has been primarily corrected, and control the communication device to transmit the identified second information to the display apparatus such that the primarily corrected overdrive table may be correctable based on the identified second information.

The controller may be further configured to: based on the third image obtained by the second sensor, recognize at least one of afterimages, reverse afterimages, or color fringing, recognize a block image from which the at least one of afterimages, reverse afterimages, or color fringing is recognized, recognize a gray value of a background image and a gray value of a text image of the recognized block image, recognize, in the overdrive table that has been primarily corrected, a setting voltage corresponding to the recognized gray value of the background image and the recognized gray value of the text image, recognize, in the recognized block image, a ratio of the recognized at least one of afterimages, reverse afterimages, or color fringing with respect to the text image, and based on the recognized ratio exceeding a reference ratio, identify the second information that includes a modification to the setting voltage of the overdrive table that has been primarily corrected such that the setting voltage of the overdrive table that has been primarily corrected is correctable based on the identified second information.

The sensor may be a first sensor, the identified information correspond to the modification to the overdrive table of the display apparatus may be identified first information, and the communication device may be further configured to communicate with a user device configured to obtain an image of a test image displayed on the display apparatus, and the controller may be further configured to: control the communication device to transmit the identified first information to the display apparatus such that a primary correction of the overdrive table of the display apparatus is performed based on the identified first information based on a third image obtained by the user device, recognize an image quality of the third image, based on the recognized image quality, identify second information corresponding to a modification to the overdrive table that has been primarily corrected, and control the communication device to transmit the identified second information to the display apparatus such that the primarily corrected overdrive table is correctable based on the identified second information.

In accordance with the present disclosure, a display apparatus may include: a communication device configured to communicate with an external device; a display panel including a liquid crystal portion in which an arrangement of liquid crystal molecules changes in response to a voltage applied to an electrode portion, the display panel configured to display a gray image with at least one gray value among a plurality of gray values according to a change of the arrangement of the liquid crystal molecules; a memory configured to store an overdrive table including a target voltage corresponding to each gray value of the plurality of gray values and a plurality of setting voltages configured to respectively change each gray value of the plurality gray values from a first gray value to a second gray value; and a controller configured to: based on a change of a gray value corresponding to a change of an image displayed through the display panel, recognize a first gray value and a second gray value, changed from the first gray value, from among the plurality of gray values, recognize a target voltage corresponding to the second gray value, recognize a setting voltage corresponding to the first gray value and the second gray value from the overdrive table, control the setting voltage to be applied to the electrode portion, and then control the target voltage to be applied to the electrode portion, and correct, according to information to correct the overdrive table being received from the external device, the overdrive table stored in the memory.

The controller may be further configured to: based on a command to correct the stored overdrive table received from the external device, control the display panel to display a first image and a second image.

The external device may include an analysis apparatus configured to analyze a response time of liquid crystals of the display panel and analyze image quality of an image on the display panel, a user device configured to obtain an image on the display panel, or a combination thereof.

In accordance with the present disclosure, a control method of an analysis apparatus including a communication device configured to communicate with a display apparatus, a sensor configured to obtain an image of a test image displayed on the display apparatus, and a controller, may include: by the controller, identifying identification information of a display apparatus, recognizing an original overdrive table of the display apparatus based on the identification information of the display apparatus, obtaining, by the sensor, a first image of a first test image displayed on the display apparatus and a second image of a second test image displayed on the display apparatus, the first image including a first plurality of gray values displayed on the display apparatus and the second image including a second plurality of gray values displayed on the display apparatus that respectively correspond to, and are different values from, the first plurality of gray values, based on the obtained first image and the obtained second image, recognizing a plurality of response times respectively corresponding to a time for the first plurality of gray values to change to the second plurality of gray values, based on a difference between the recognized plurality of response times and a reference response time, identifying information corresponding to a modification to the original overdrive table of the display apparatus, and transmitting the identified information to the display apparatus such that the original overdrive table of the display apparatus is correctable based on the identified information.

A correction of the original overdrive table of the display apparatus may include: by the controller, recognizing at least one response time among the recognized plurality of response times that exceeds the reference response time, recognizing a first gray value among the first plurality of gray values and a second gray value among the second plurality of gray values which respectively correspond to the recognized at least one response time, recognizing a setting voltage of the original overdrive table that corresponds to the first gray value and the second gray value, and based on to the first gray value being smaller than the second gray value, increasing the recognized setting voltage by a first voltage to correct the original overdrive table, or based on the first gray value being greater than the second gray value, decreasing the recognized setting voltage by a second voltage to correct the original overdrive table.

The sensor may be a first sensor, the identified information correspond to the modification to the overdrive table of the display apparatus is identified first information, and the analysis apparatus further includes a second sensor configured to obtain an image of a test image displayed on the display apparatus, and the method may further include: by the controller, based on the recognized plurality of response times being shorter than or equal to the reference response time, control the communication device to transmit the identified first information to the display apparatus such that a primary correction of the overdrive table of the display apparatus is performed based on the identified first information, obtaining, by the second sensor, a third image of a third test image displayed on the display apparatus, recognizing an image quality of the third image, based on the recognized image quality, identify second information corresponding to a modification to the original overdrive table that has been primarily corrected, and transmitting the identified second information to the display apparatus such that the primarily corrected overdrive table is correctable based on the identified second information.

A correction of the primarily corrected overdrive table based on the recognized image quality includes: based on the third image obtained by the second sensor, recognizing at least one of afterimages, reverse afterimages, or color fringing, recognizing a block image from which the at least one of afterimages, reverse afterimages, or color fringing is recognized, recognizing a gray value of a background image and a gray value of a text image of the recognized block image, recognizing, in the overdrive table that has been primarily corrected, a setting voltage corresponding to the recognized gray value of the background image and the recognized gray value of the text image, recognizing, in the recognized block image, a ratio of the recognized at least one of afterimages, reverse afterimages, or color fringing with respect to the text image, and based on the recognized ratio exceeding a reference ratio, identifying the second information that includes a modification to the setting voltage of the overdrive table that has been primarily corrected such that the setting voltage of the overdrive table that has been primarily corrected is correctable based on identified second information.

### Advantageous Effects

According to the present disclosure, it may be possible to satisfy response speed performance of a display apparatus and improve image quality of images.

According to the present disclosure, it may be possible to automatically correct an overdrive table.

According to the present disclosure, it may be possible to improve quality of outputs of a display apparatus and enhance automation performance of the display apparatus by repeatedly correcting a response speed of liquid crystals to determine a final setting voltage of an overdrive table (OD table).

According to the present disclosure, it may be possible to correct image quality of a display apparatus at a user's desired time according to the user's need and thereby reduce a service time and service cost for image quality improvement of the display apparatus by recognizing image quality information of the display apparatus through a user device and correcting an overdrive table based on the image quality information of the display apparatus. Therefore, the present disclosure may improve the user's satisfaction.

According to the present disclosure, it may be possible to improve quality and marketability of a display apparatus, further increase a user's satisfaction, and secure competitiveness of the display apparatus.

### DESCRIPTION OF DRAWINGS

FIG. 1 shows an appearance of a display apparatus according to an embodiment.

FIG. 2 is a detailed configuration diagram of a display panel provided in a display apparatus according to an embodiment.

FIG. 3 shows an example of an arrangement of liquid crystal molecules in a display apparatus according to an embodiment.

FIG. 4 shows an example of overdrive control of a display apparatus according to an embodiment.

FIG. 5 shows an example of an overdrive table stored in a display apparatus according to an embodiment.

FIG. 6 shows a control configuration of an analysis apparatus for analyzing a display apparatus according to an embodiment.

FIGS. 7 and 8 show examples of first analyzed images obtained by an analysis apparatus for analyzing a display apparatus according to an embodiment.

FIGS. 9 and 10 show examples of second analyzed images obtained by an analysis apparatus for analyzing a display apparatus according to an embodiment.

FIG. 11 shows an example of a response time table recognized by an analysis apparatus for analyzing a display apparatus according to an embodiment.

FIG. 12 shows an example of image quality recognition by an analysis apparatus for analyzing a display apparatus according to an embodiment.

FIG. 13 shows another example of image quality recognition by an analysis apparatus for analyzing a display apparatus according to an embodiment.

FIG. 14 is a control configuration diagram of a display apparatus according to an embodiment.

FIG. 15 is a control flowchart of an analysis apparatus for primarily correcting an overdrive table of a display apparatus according to an embodiment.

FIG. 16 is a control flowchart of an analysis apparatus for secondarily correcting an overdrive table of a display apparatus according to an embodiment.

FIG. 17 is a control configuration diagram of a display apparatus according to another embodiment.

### MODES OF THE INVENTION

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

As used herein, the term “and/or” includes any and all combinations of one or more of associated listed items.

Terms such as “1^{st}”, “2^{nd}”, or “first” or “second” may be used simply to distinguish a component from other components, without limiting the component in other aspects (e.g., importance or order).

A certain (e.g., a first) component is referred to as “coupled” or “connected” with or without the terms “functionally” or “communicatively” to another (e.g., second) component. When mentioned, it means that any of the above components can be connected to the other components directly (e.g., by wire), wirelessly, or via a third component.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

It will be understood that when a certain component is referred to as being “connected to”, “coupled to”, “supported by” or “in contact with” another component, it can be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a component is referred to as being “on” or “over” another component, it can be directly on the other component or intervening components may also be present.

Hereinafter, an embodiment of the present disclosure will be described in detail with reference to the accompanying drawings.

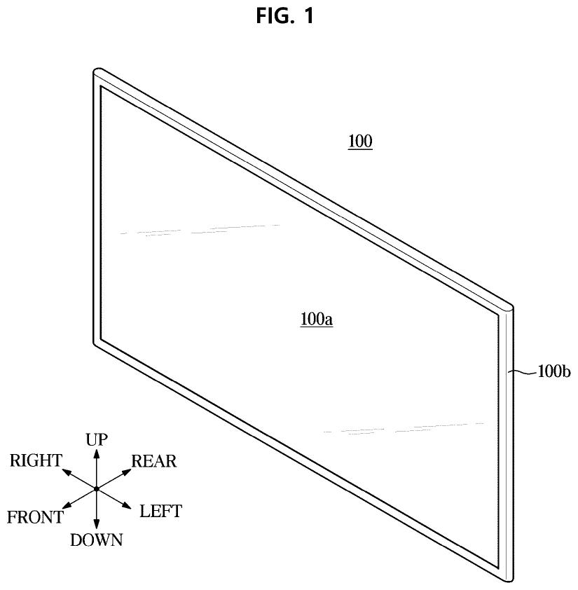

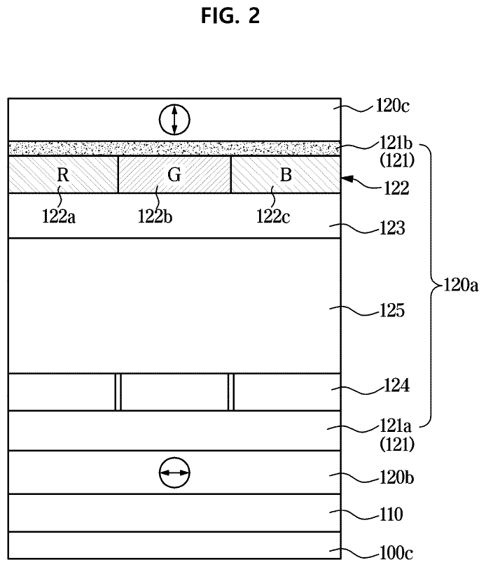

FIG. 1 shows an appearance of a display apparatus according to an embodiment, and FIG. 1 will be described with reference to FIGS. 2 to 5.

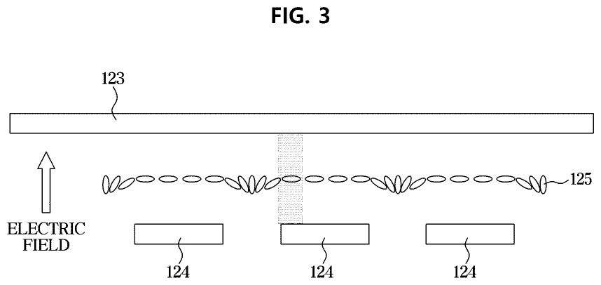

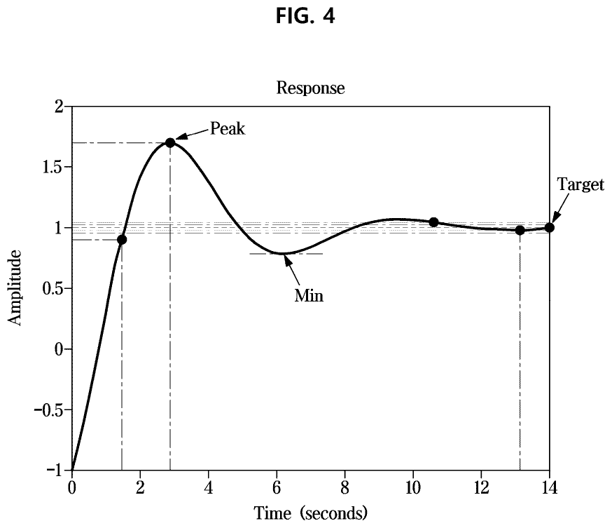

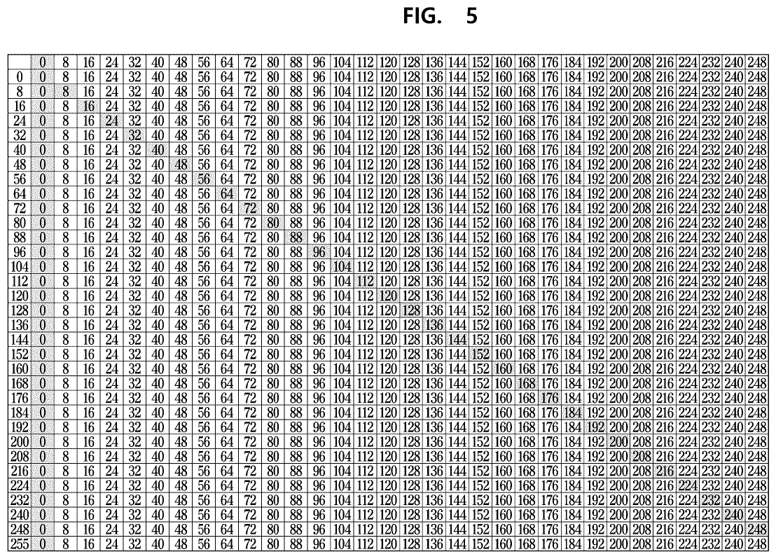

FIG. 2 is a detailed configuration diagram of a display panel provided in a display apparatus according to an embodiment, FIG. 3 shows an example of an arrangement of liquid crystal molecules in a display apparatus according to an embodiment, FIG. 4 shows an example of overdrive control of a display apparatus according to an embodiment, and FIG. 5 shows an example of an overdrive table stored in a display apparatus according to an embodiment.

A display apparatus 100 may be an apparatus that displays visual and three-dimensional image information, such as a display of a user device (for example, a notebook, a smart phone, a tablet, etc.), a monitor of a personal computer (PC), a television, a display of a home appliance, a display in a vehicle, a billboard, a guide sign, etc.

The display apparatus 100 may display an image received from an external device or an image stored in the display apparatus 100. The external device may include a set-top box, external memory, a notebook, a user device, etc.

As an example of the display apparatus 100 according to an embodiment, a television will be described.

The display apparatus 100 may include a main body 100a forming an appearance of the display apparatus 100.

The display apparatus 100 may further include a bezel 100b provided at edges of the main body 100a. The display apparatus 100 may be protected from an external force due to the bezel 100b.

The display apparatus 100 may be implemented as a bezel-less type.

The display apparatus 100 may further include a stand provided in a lower portion of the main body 100a and supporting the main body 100a, or a bracket provided on a rear side of the main body 100a to mount the main body 100a on a wall or the like, in correspondence to an installation environment and function.

As shown in FIG. 2, the display apparatus 100 may further include a case 100c coupled to the bezel 100b, positioned on the rear side, and forming a rear appearance. The display apparatus 100 may include a backlight unit 110 and a display panel 120 positioned between the bezel 100b and the case 100c.

The display panel 120 may display an image by using light from the backlight unit 110.

The display apparatus 100 may be a liquid crystal display. The liquid crystal display according to an embodiment may be a liquid crystal display in a vertical alignment (VA) mode. The liquid crystal display in the VA mode may be a liquid crystal display in which long axes of liquid crystal molecules are vertically arranged between two substrates while no electric field is applied.

The backlight unit 110 of the display apparatus 100 may be classified into a direct type backlight unit and an edge type backlight unit according to a location thereof.

The display apparatus 100 may further include a touch panel (not shown) provided in front of the display panel 120.

A configuration of the display panel 120 will be described in more detail.

The display panel 120 may include a liquid crystal panel 120a, a first polarization panel 120b provided to one side of the liquid crystal panel 120a, and a second polarization panel 120c provided to another side of the liquid crystal panel 120a.

The liquid crystal panel 120a may include a substrate portion 121, a color filter portion 122, a first electrode portion 123, a second electrode portion 124, and a liquid crystal portion 125, which are laminated to each other.

The substrate portion 121 may include first and second substrates 121a and 121b attached to each other with a sealant.

The first and second substrates 121a and 121b may be glass substrates.

The first substrate 121a of the substrate portion 121 may be positioned adjacent to the first polarization panel 120b.

The first and second substrates 121a and 121b of the substrate portion 121 may support the first electrode portion 123, the second electrode portion 124, and the liquid crystal portion 125 such that positions and states of the first electrode portion 123, the second electrode portion 124, and the liquid crystal portion 125 are maintained.

The substrate portion 121 may include a rigid substrate, a flexible substrate, or a rigid-flexible substrate, and may include a glass substrate.

In a case where the substrate portion 121 is implemented as a flexible substrate, the display apparatus 100 may be curved with a certain curvature.

The color filter portion 122 may be positioned adjacent to the second polarization panel 120c or the second substrate 121b.

The color filter portion 122 may be positioned adjacent to the first electrode portion 123.

The color filter portion 122 may convert incident light into red light, green light, and blue light and emit the converted light.

The color filter portion 122 may include a red filter (R) 122a that converts incident light into red light, a green filter (G) 122b that converts incident light into green light, and a blue filter (B) 122c that converts incident light into blue light.

Here, the red filter 122a, the green filter 122b, and the blue filter 122c may be adjacent to each other to form one RGB filter. The one RGB filter may form one pixel.

The color filter portion 122 may express a color by emitting at least one of red light emitted from the red filter 122a, green light emitted from the green filter 122b, or blue light emitted from the blue filter 122c to outside, or by mixing at least two of red light emitted from the red filter 122a, green light emitted from the green filter 122b, and blue light emitted from the blue filter 122c and emitting the mixed light to the outside.

Light converted by each filter of the color filter unit 122 may be emitted to the outside through the second polarizing panel 120c.

The first electrode portion 123 may be positioned between the second substrate 121b and the liquid crystal portion 125.

The first electrode portion 123 may be positioned between the color filter portion 122 and the liquid crystal portion 125.

The first electrode portion 123 may be a common electrode. The first electrode portion 123 may be a ground electrode. A preset reference voltage may be applied to the first electrode portion 123.

An electric field may be formed between the first electrode portion 123 and the second electrode portion 124.

The first electrode portion 123 may orient liquid crystal molecules within the liquid crystal portion 125 by an electric field formed in the liquid crystal portion 125.

The second electrode portion 124 may be positioned adjacent to the first substrate 121a.

The second electrode portion 124 may be positioned between the first substrate 121a and the liquid crystal portion 125.

The second electrode unit 124 may include a pixel electrode that forms an electric field by using an electrical force of the first electrode portion 123.

The pixel electrode may correspond to each pixel. The pixel electrode may correspond to a RGB filter.

The pixel electrode may include a sub-pixel electrode corresponding to the red filter 122a, a sub-pixel electrode corresponding to the green filter 122b, and a sub-pixel electrode corresponding to the blue filter 122c. That is, a plurality of sub-pixel electrodes of the second electrode portion 124 may be arranged in correspondence to positions of the red filter 122a, the green filter 122b, and the blue filter 122c of the color filter portion 122, respectively.

The plurality of sub pixel electrodes of the second electrode portion 124 may be applied the same voltage or different voltages.

The sub pixel electrodes may be applied a voltage that is the same as the reference voltage or a voltage that is different from the reference voltage.

For example, in a case where the reference voltage is a voltage a, a voltage between a voltage b and a voltage c may be applied to the second electrode portion 124. The voltage b may be lower than the voltage a and the voltage c may be higher than the voltage a. Also, the voltage a may be any voltage between the voltage b and the voltage c.

An electric field may be formed in the liquid crystal portion 125 due to a difference between a voltage applied to the sub pixel electrodes and a voltage applied to the common electrode.

A magnitude of the electric field formed in the liquid crystal portion 125 may depend on the difference between the voltage applied to the sub pixel electrodes and the voltage applied to the common electrode.

According to a voltage applied to the sub pixel electrodes, a direction of electric force lines of an electric field formed in the liquid crystal portion 125 may be set, or no electric field may be formed in the liquid crystal portion 125.

The plurality of sub pixel electrodes of the second electrode portion 124 may share the first electrode portion 123.

The second electrode portion 124 may be opposite to the first electrode portion 123 with the liquid crystal portion 125 in between.

The plurality of sub pixel electrodes of the second electrode portion 124 may be implemented by using thin film transistors (TFTs).

The liquid crystal portion 125 may be positioned between the first electrode portion 123 and the second electrode portion 124 and include a plurality of liquid crystals. Here, the liquid crystals may be liquid crystal molecules.

The liquid crystals may be randomly arranged while no electric field is formed. While an electric field is formed, the liquid crystals may be oriented according to a direction of the electric field.

As shown in FIG. 3, while an electric field is formed between the pixel electrodes of the second electrode portion 124 and the common electrode of the first electrode portion 123, the liquid crystal molecules of the liquid crystal portion 125 may be arranged horizontally in areas corresponding to flat surfaces of the sub pixel electrodes of the second electrode portion 124 among areas of the liquid crystal portion 125, and may be, in areas corresponding to edges of the sub pixel electrodes, arranged horizontally to electric force lines to correspond to a direction in which the electric force lines are formed.

An orientation angle of liquid crystal molecules on the flat surfaces of the sub pixel electrodes of the second electrode portion 124 may be different from an orientation angle of liquid crystal molecules on the edges of the sub pixel electrodes of the second electrode portion 124.

While no electric field is formed between the pixel electrodes of the second electrode portion 124 and the common electrode of the first electrode portion 123, the long axes of the liquid crystal molecules of the liquid crystal portion 125 may be vertically oriented between the two substrates.

An orientation angle of the liquid crystal molecules of the liquid crystal portion 125 may be adjusted depending on a voltage applied through the second electrode portion 124. As a magnitude of a voltage applied through the second electrode portion 124 increases, the liquid crystal molecules of the liquid crystal portion 125 may be oriented closer to a horizontal direction.

That is, an orientation angle of the liquid crystal molecules of the liquid crystal portion 125 may depend on a voltage applied to the second electrode 124.

The liquid crystal portion 125 may output an amount of light corresponding to an orientation angle of the liquid crystal molecules. The liquid crystal portion 125 may adjust brightness of an image displayed through the display panel 120 by adjusting an orientation angle of the liquid crystal molecules. The liquid crystal portion 125 may adjust brightness of an image output through each pixel.

Here, brightness may be gradation (also called a color intensity or shade). The gradation may be defined as gray scales. The number of colors displayed on the display apparatus 100 may depend on gray scales.

The number of brightness levels for each pixel, output through the liquid crystal portion 125 may depend on n bits of gray scale, wherein n may be a natural number.

For example, in the case of 3 bits of gray scale, 8 gray values from a black color to a white color may be expressed, and each pixel of the liquid crystal portion 125 may output brightness of 8 levels.

As another example, in the case of 8 bits of gray scale, 256 gray values from a black color to a white color may be expressed, and each pixel of the liquid crystal portion 125 may output brightness of 256 levels.

As another example, in the case of 10 bits of gray scale, 1024 gray values from a black color to a white color may be expressed, and each pixel of the liquid crystal portion 125 may output brightness of 1024 levels.

However, the above-mentioned bits of gray scale may be an example, and bits of gray scale are not limited thereto.

The display apparatus 100 may display a richer, more sophisticated, and more detailed image with more gray scales.

The display apparatus 100 may store a target voltage for displaying a gray image for each gray value.

The display apparatus 100 may store, for each gray value, a maximum voltage corresponding to a decrease of the gray value, and a minimum voltage corresponding to an increase of the gray value.

The display apparatus 100 may change a gray value of the liquid crystal portion 125 based on a change of an image to be displayed. Changing a gray value of the liquid crystal portion 125 may include changing a gray value of at least one pixel.

The display apparatus 100 may change a target voltage that is applied to the liquid crystal portion 125 to change a gray value of the liquid crystal portion 125.

While the display apparatus 100 changes a gray value of the liquid crystal portion 125, the display apparatus 100 may adjust a voltage that is applied to the liquid crystal portion 125 to a voltage that is higher or lower than a target voltage and then maintain the voltage at the target voltage, thereby increasing a response speed of the liquid crystal portion 125.

Applying a voltage to the liquid crystal portion 125 may include applying a voltage to the first and second electrode portions 123 and 124.

8 bits of gray scale in which a gray value of a black color is set to 0 and a gray value of a white color is set to 255 will be described as an example.

For example, for the display apparatus 100 to increase a gray value of the liquid crystal portion 125, the display apparatus 100 may raise a voltage that is applied to the liquid crystal portion 125 by a preset voltage from a target voltage, and when the voltage applied to the liquid crystal portion 125 reaches the target voltage, the display apparatus 100 may maintain the voltage applied to the liquid crystal portion 125 at the target voltage.

Another example will be described with reference to FIG. 4. While the display apparatus 100 increases a gray value of the liquid crystal portion 125, the display apparatus 100 may raise a voltage that is applied to the liquid crystal portion 125 up to a preset voltage Peak that is higher than a target voltage Target, and when the voltage applied to the liquid crystal portion 125 reaches the preset voltage Peak, the display apparatus 100 may lower the voltage applied to the liquid crystal portion 125 to a preset minimum voltage min. When the voltage applied to the liquid crystal portion 125 reaches the preset minimum voltage min, the display apparatus 100 may raise the voltage applied to the liquid crystal portion 125 to the target voltage Target, and when the voltage applied to the liquid crystal portion 125 reaches the target voltage Target, the display apparatus 100 may maintain the voltage applied to the liquid crystal portion 125 at the target voltage Target.

As another example, while the display apparatus 100 decrease a gray value of the liquid crystal portion 125, the display apparatus 100 may lower a voltage that is applied to the liquid crystal portion 125 by a preset voltage from a target voltage, and when the voltage applied to the liquid crystal portion 125 reaches the target voltage, the liquid crystal portion 125 may maintain the voltage applied to the liquid crystal portion 125 at the target voltage.

As another example, while the display apparatus 100 decreases a gray value of the liquid crystal portion 125, the display apparatus 100 may lower a voltage that is applied to the liquid crystal portion 125 to a preset voltage that is lower than a target voltage, and when the voltage applied to the liquid crystal portion 125 reaches the preset voltage, the display apparatus 100 may raise the voltage applied to the liquid crystal portion 125 up to a preset maximum voltage. When the voltage applied to the liquid crystal portion 125 reaches the preset maximum voltage, the display apparatus 100 may lower the voltage applied to the liquid crystal portion 125 to the target voltage, and when the voltage applied to the liquid crystal portion 125 reaches the target voltage, the display apparatus 100 may maintain the voltage applied to liquid crystal portion 125 at the target voltage.

As shown in FIG. 5, the display apparatus 100 may include an overdrive table that stores information on a preset voltage that is applied to the liquid crystal portion 125 to correspond to a change of a gray value. Here, the preset voltage may be a peak voltage. Hereinafter, the preset voltage is referred to as a setting voltage.

The overdrive table may store setting voltages of each gray value for changed gray values.

For example, a horizontal axis of the overdrive table may be initial gray values for rising overdrive control and may be changed gray values for falling overdrive control. A vertical axis of the overdrive table may be changed gray values for rising overdrive control and may be initial gray values for falling overdrive control.

The overdrive table may be corrected by an analysis apparatus while the display apparatus 100 is manufactured, and then stored in the display apparatus 100.

The overdrive table may be corrected by a user device based on a user's need after the display apparatus 100 is manufactured, and then stored in the display apparatus 100.

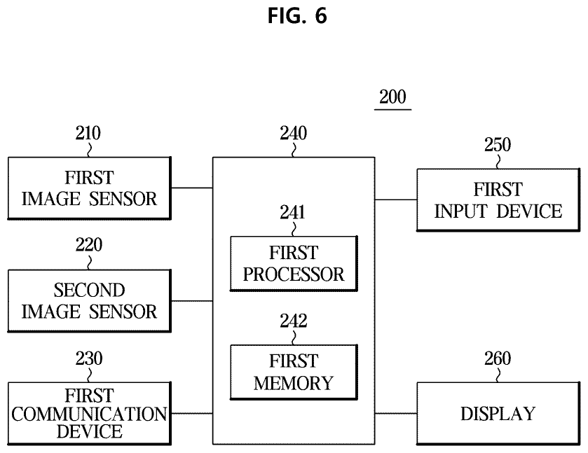

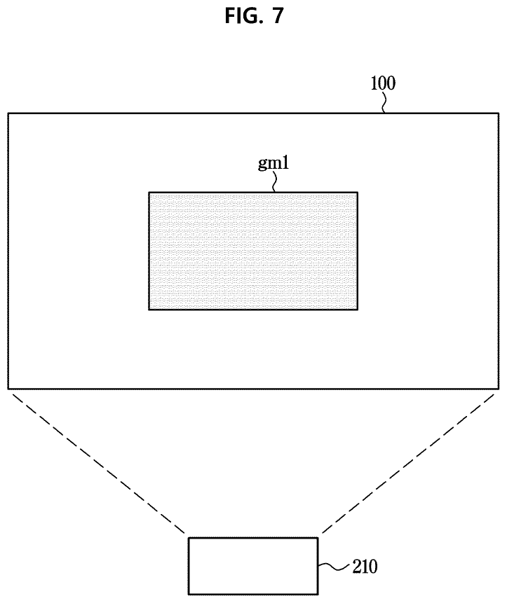

FIG. 6 is a control configuration diagram of an analysis apparatus for analyzing a display apparatus according to an embodiment, and FIG. 6 will be described with reference to FIGS. 7 to 13.

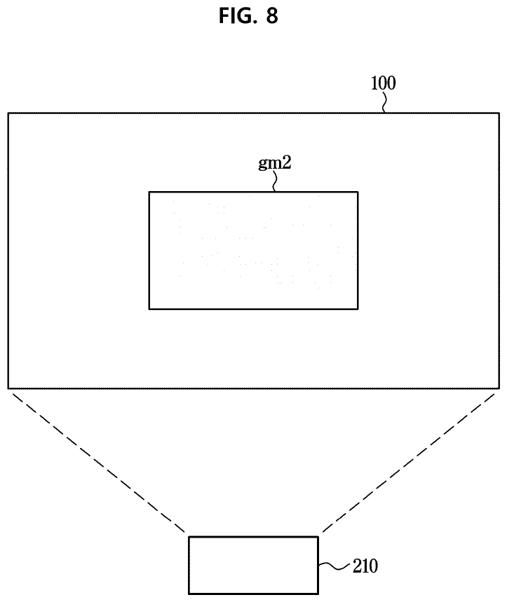

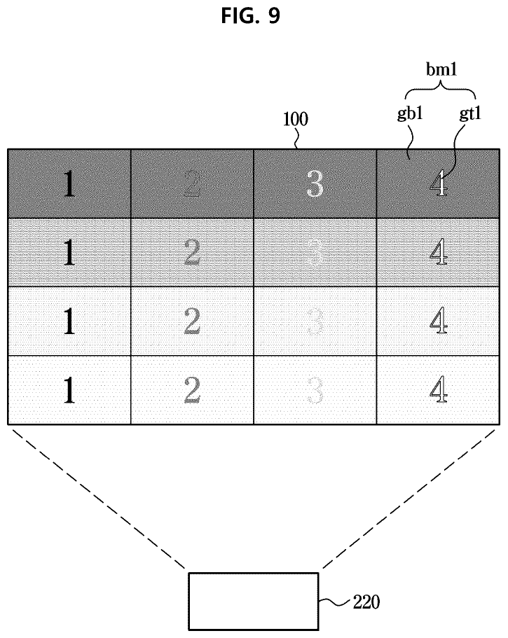

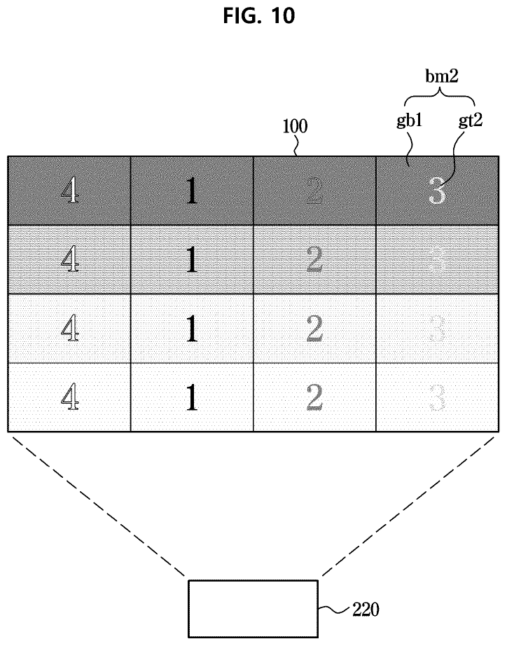

FIGS. 7 and 8 show examples of first analyzed images obtained by an analysis apparatus for analyzing a display apparatus according to an embodiment, and FIGS. 9 and 10 show examples of second analyzed images obtained by an analysis apparatus for analyzing a display apparatus according to an embodiment.

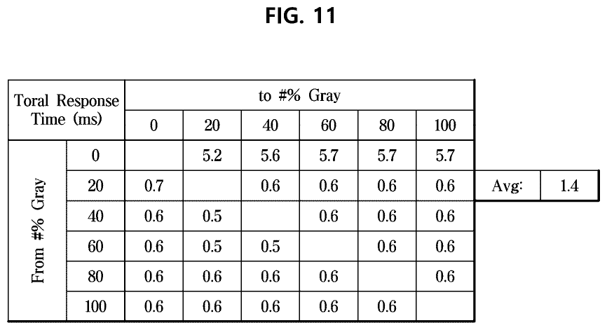

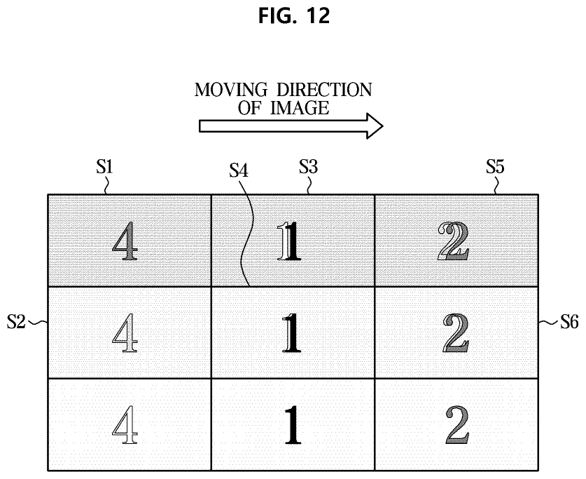

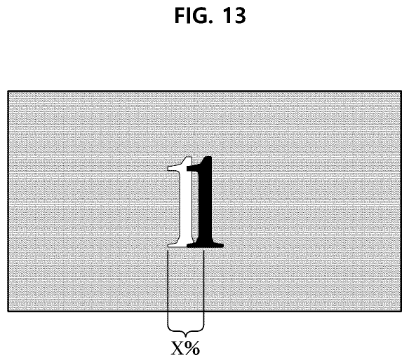

FIG. 11 shows an example of a response time table recognized by an analysis apparatus for analyzing a display apparatus according to an embodiment, FIG. 12 shows an example of image quality recognition by an analysis apparatus for analyzing a display apparatus according to an embodiment, and FIG. 13 shows another example of image quality recognition by an analysis apparatus for analyzing a display apparatus according to an embodiment.

An analysis apparatus 200 may analyze a response speed of the liquid crystals provided in the display apparatus 100 and image quality of an image displayed on the display apparatus 100, and correct the overdrive table based on at least one of the analyzed response time of the liquid crystals or the analyzed image quality of the image.

The response speed is also referred to as a response time.

The analysis apparatus 200 may include a first image sensor 210, a second image sensor 220, a first communication device 230, and a first controller 240, and further include a first input device 250 and a display 260.

To distinguish components of the analysis apparatus 200 from those of the display apparatus 100, some components having the same names as those of the display apparatus 100 may be designated as ‘first’.

The first image sensor 210 may obtain a first test image displayed on the display apparatus 100 as a first analyzed image.

The first analyzed image may be an image based on which a response speed of the liquid crystals of the display apparatus 100 is analyzed.

The first test image may be an image based on which a response speed of the liquid crystals of the display apparatus 100 is tested.

The first analyzed image and the first test image may be a plurality of gray images having different gray values. To distinguish a plurality of gray images displayed on the display apparatus 100 from a plurality of gray images obtained by the first image sensor 210, a plurality of gray images displayed on the display apparatus 100 are referred to as first test images, and a plurality of gray images obtained by the first image sensor 210 of the analysis apparatus 200 are referred to first analyzed images.

The first image sensor 210 may sequentially obtain a plurality of first test images as a plurality of first analyzed images.

As shown in FIGS. 7 and 8, the first image sensor 210 may obtain a gray image gm1 having a first gray value, displayed on the display apparatus 100 and then obtain a gray image gm2 having a second gray value, displayed on the display apparatus 100. While the display apparatus 100 displays gray images, the first image sensor 210 may obtain all the gray images displayed on the display apparatus 100.

The first image sensor 210 may transmit the first analyzed images sequentially obtained to the first controller 240. That is, the first image sensor 210 may sequentially transmit the plurality of first analyzed images for the plurality of first test images sequentially obtained to the first controller 240.

The first image sensor 210 may obtain a first test image as a first analyzed image in real time, match the first analyzed image with real-time information, and transmit the first analyzed image matching with the real-time information to the first controller 240.

The first image sensor 210 may identify whether a gray value has changed, based on the obtained first analyzed image, and according to the gray value being identified to have changed, the first image sensor 210 may transmit information on a time at which the gray value has changed to the first controller 240.

The first image sensor 210 may include a camera for obtaining a gray image.

The first image sensor 210 may include a camera for recognizing a change of a gray value.

The second image sensor 220 may obtain a second test image displayed on the display apparatus 100 as a second analyzed image.

The second analyzed image may be an image based on which image quality of an image displayed on the display apparatus 100 is analyzed.

The second test image may be an image based on which image quality of an image displayed on the display apparatus 100 is tested.

The second analyzed image and the second test image may include a plurality of block images arranged in rows and columns. The plurality of block images may have the same size.

In a case where the plurality of block images are n block images, the n block images may include background images and text images displayed in the background images. That is, the number of background images and the number of text images may correspond to the number of block images.

To distinguish a plurality of block images displayed on the display apparatus 100 from a plurality of block images obtained by the second image sensor 220 of the analysis apparatus 200, a plurality of block images displayed on the display apparatus 100 are referred to as second test images, and a plurality of block images obtained by the second image sensor 220 of the analysis apparatus 200 are referred to as second analyzed images.

N background images may be images respectively displayed in n block images and have different gray values in different columns.

The n background images may be arranged in the n block images based on magnitudes of gray values.

N text images may be images respectively displayed in the n block images and have different gray values in different rows.

Second test images displayed on the display apparatus 100 may change at second reference time intervals.

The second test images displayed on the display apparatus 100 may include images in which n text images change at the second reference time intervals.

The second test images displayed on the display apparatus 100 may include images in which n text images move to the left columns at the second reference time intervals in the same rows and are displayed in background images of the left columns.

The second test images displayed on the display apparatus 100 may include images in which n text images move to the right columns at the second reference time intervals in the same rows and are displayed in background images of the right columns.

The second image sensor 220 may obtain the second test images displayed on the display apparatus 100 as second analyzed images in real time, and transmit the second analyzed images obtained in real time to the first controller 240.

As shown in FIGS. 9 and 10, the second image sensor 220 may obtain a first block image bm1 displayed on the display apparatus 100 and then obtain a second block image bm2 displayed on the display apparatus 100. While the display apparatus 100 displays block images, the second image sensor 220 may obtain all the block images displayed on the display apparatus 100.

FIGS. 9 and 10 show an example in which 16 block images are displayed. However, the number of block images is not limited thereto.

First block images bm1 displayed on the display apparatus 100 may include n background images gb1 corresponding to bits of gray scale, and n text images gt1 displayed in the n background images gb1.

Second block images bm2 displayed on the display apparatus 100 may include n background images gb1 and n text images gt1 displayed in the n background images gb1.

In the first and second block images bm1 and bm2, background images in the same rows may have the same gray values, and background images in different rows may have different gray values.

In the first and second block images bm1 and bm2, text images in the same columns may have the same gray values and text images in different columns may have different gray values.

The second block images bm2 displayed on the display apparatus 100 may be images in which all text images gt2 in the first block images bm1 displayed on the display apparatus 100 have moved to the left columns.

The second image sensor 220 may include a dedicated image quality detection camera for obtaining an image from which image quality is analyzed. Here, the image quality may include afterimages, reverse afterimages, and color fringing.

The second image sensor 220 may include, but is not limited to, a Charge-Coupled Device (CCD) or a Complementary Metal Oxide Semiconductor (CMOS) image sensor.

The first communication device 230 may perform communication between internal components of the analysis apparatus 200 or communicate with the display apparatus 100.

The first communication device 230 may transmit a display command for a first test image and a display command for a second test image to the display apparatus 100 based on a control command from the first controller 240.

The first communication device 230 may request the display apparatus 100 to send identification information of the display apparatus 100, and may also transmit identification information of the display apparatus 100 received from the display apparatus 100 to the first controller 240.

The first communication device 230 may transmit the overdrive table to the display apparatus 100 based on a control command from the first controller 240.

The first communication device 230 may establish a direct (e.g., wired) or wireless communication channel with the display apparatus 100 and support communication through the established communication channel.

According to an embodiment, the first communication device 230 may include a wireless communication module (e.g., a cellular communication module, a short-range wireless communication module, or a global navigation satellite system (GNSS) communication module), or a wired communication module (e.g., a local area network (LAN) communication module or a power line communication module).

A corresponding communication module among the communication modules may communicate with an external device through a first network (e.g., a short-range communication network, such as Bluetooth, wireless fidelity (WiFi) direct, or infrared data association (IrDA)) or a second network (e.g., a telecommunication network, such as a legacy cellular network, a 5G network, a next-generation communication network, internet, or a computer network (for example, a local area network (LAN) or a wide area network (WAN)). Such various kinds of communication modules may be integrated into a component (e.g., a single chip) or implemented as a plurality of independent components (e.g., a plurality of chips).

The short-range wireless communication module may include a Bluetooth communication module, a Bluetooth Low Energy (BLE) communication module, a Near Field Communication (NFC) communication module, a Wireless Local Area Network (WLAN; WiFi) communication module, a Zigbee communication module, an IrDA communication module, a Wi-Fi Direct (WFD) communication module, a Ultrawideband (UWB) communication module, an Ant+communication module, a microwave (uWave) communication module, etc., but the present disclosure is not limited thereto.

The first controller 240 may be electrically connected to various components and/or devices of the analysis apparatus 200 and control the various components and/or devices. That is, the first controller 240 may control overall operations of the analysis apparatus 200.

The first controller 240 may control operations of the analysis apparatus 200 based on a user input received by the first input device 250.

The first controller 240 may control the display 260 to output output information related to an operation of the analysis apparatus 200. The first controller 240 will be described in more detail.

The first controller 240 may identify a connection to the display apparatus 100 and according to the first controller 240 identifying a connection to the display apparatus 100, the first controller 240 may transmit an operation command to the display apparatus 100.

The connection to the display apparatus 100 may include a connection by wired communication and a connection by wireless communication.

The operation command may include a display command for a first test image and a display command for a second test image.

The operation command may include an execution command for a first program and an execution command for a second program.

The first controller 240 may request the display apparatus 100 to send identification information of the display apparatus 100 and receive identification information of the display apparatus 100 from the display apparatus 100.

The first controller 240 may receive the identification information of the display apparatus 100 from the first input device 250.

The first controller 240 may request specification information of a main chip or identification information of the main chip related to image display of the display apparatus 100, and receive the specification information of the main chip or the identification information of the main chip from the display apparatus 100.

The first controller 240 may recognize a gray scale based on the identification information of the display apparatus 100, the specification information of the main chip, or the identification information of the main chip.

The first control unit 240 may also recognize an overdrive table based on the identification information of the display apparatus 100, the specification information of the main chip, or the identification information of the main chip.

For example, according to the first controller 240 receiving identification information of the display apparatus 100 from the display apparatus 100, the first controller 240 may recognize an overdrive table corresponding to the identification information of the display apparatus 100 from information stored in a server (not shown) or memory (not shown) and store the recognized overdrive table.

The overdrive table corresponding to the identification information of the display apparatus 100, the specification information of the main chip, or the identification information of the main chip may have been stored in the server (not shown) or memory (not shown).

The first controller 240 may also request the display apparatus 100 to send an overdrive table and receive the overdrive table from the display apparatus 100. The overdrive table received from the display apparatus 100 may be an original overdrive table.

The first controller 240 may control the first communication device 230 to transmit a first program for testing a response speed of the liquid crystals to the display apparatus 100, and control the first communication device 230 to transmit a second program for testing image quality of an image to the display apparatus 100. Here, the first program may be a program for displaying a first test image. The second program may be a program for displaying a second test image.

The first controller 240 may control the display 260 to display the identification information of the display apparatus 100 and control the display 260 to display analysis progress information.

The first controller 240 may control the display 260 to display information about an analysis result.

The first controller 240 may control the display 260 to display transmission information of a corrected overdrive table.

The first controller 240 may primarily correct the overdrive table based on a first analyzed image received through the first image sensor 210, and secondarily correct the primarily corrected overdrive table based on a second analyzed image received through the second image sensor 220.

When the first controller 240 primarily corrects the overdrive table based on the first analyzed image received through the first image sensor 210, the first controller 240 may primarily correct the overdrive table until a recognized response time is included in a reference response time range. That is, the first controller 240 may repeatedly correct the overdrive table until a recognized response time is included in the reference response time range.

When the first controller 240 repeatedly corrects the overdrive table based on the response time, the first controller 240 may transmit the corrected overdrive table to the display apparatus 100 and transmit a command for displaying a first test image by using the corrected overdrive table to the display apparatus 100.

Whenever the display apparatus 100 displays the first test image by using the corrected overdrive table, the first controller 240 may repeat a process of correcting the overdrive table based on a first analyzed image for the first test image.

When the first controller 240 secondarily corrects the overdrive table based on a second analyzed image received through the second image sensor 220, the first controller 240 may repeatedly correct the overdrive table based on recognized image quality being identified to be in an abnormal state.

When the first controller 240 repeatedly corrects the overdrive table based on image quality, the first controller 240 may transmit the corrected overdrive table to the display apparatus 100 and transmit a command for displaying a second test image by using the corrected overdrive table to the display apparatus 100.

Whenever the display apparatus 100 displays the second test image by using the corrected overdrive table, the first controller 240 may repeat a process of correcting the overdrive table based on a second analyzed image for the second test image.

When the first controller 240 secondarily corrects the overdrive table based on a second analyzed image received through the second image sensor 220, the first controller 240 may secondarily finally correct the overdrive table based on recognized image quality being identified to be in a normal state. That is, the first controller 240 may repeatedly correct the overdrive table until image quality of an image is identified to be in a normal state.

Correcting the overdrive table based on a response speed is referred to as primary correction, and correcting the overdrive table based on image quality is referred to as secondary correction. However, the order of correction may be reversed.

Any one of correcting the overdrive table based on a response speed or correcting the overdrive table based on image quality may be performed.

Primary correction and secondary correction of the overdrive table by the first controller 240 will be described in more detail.

### Primary Correction of the Overdrive Table

The first controller 240 may recognize a response speed at which a gray image having an initial gray value changes to a gray image having a changed gray value, based on a first analyzed image received from the first image sensor 210.

Here, the response speed may include a response time.

The changed gray value may be greater or smaller than the initial gray value.

An example of recognizing response times of when a first gray image (maximum gray value of 0%) is displayed, when a second gray image (maximum gray value of 20%) is displayed, when a third gray image (maximum gray value of 40%) is displayed, when a fourth gray image (maximum gray value of 60%) is displayed, when a fifth gray image (maximum gray value of 80%) is displayed, and when a sixth gray image (maximum gray value of 100%) is displayed will be described with reference to a response time table shown in FIG. 11.

For example, the first controller 240 may recognize a first time at which the first gray image has been obtained by the first image sensor 210, a second time at which the second gray image has been obtained by the first image sensor 210, a third time at which the third gray image has been obtained by the first image sensor 210, a fourth time at which the fourth gray image has been obtained by the first image sensor 210, a fifth time at which the fifth gray image has been obtained by the first image sensor 210, and a sixth time at which the sixth gray image has been obtained by the first image sensor 210.

The first controller 240 may recognize a first response time taken for the first gray image to change to the first gray image based on an initial time corresponding to a test start time and the first time, recognize a second response time taken for the first gray image to change to the second gray image based on the initial time and the second time, recognize a third response time taken for the first gray image to change to the third gray image based on the initial time and the third time, recognize a fourth response time taken for the first gray image to change to the fourth gray image based on the initial time and the fourth time, recognize a fifth response time taken for the first gray image to change to the fifth gray image based on the initial time and the fifth time, and recognize a sixth response time taken for the first gray image to change to the sixth gray image based on the initial time and the sixth time.

The first controller 240 may recognize a seventh response time taken for the second gray image to change to the first gray image based on the initial time corresponding to a test start time, a first reference time, and a seventh time at which the first gray image has been obtained, recognize an eighth response time taken for the second gray image to change to the second gray image based on an eighth time at which the second gray image has been obtained, recognize a ninth response time taken for the second gray image to change to the third gray image, based on the initial time, the first reference time, and a ninth time at which the third gray image has been obtained, recognize a tenth response time taken for the second gray image to change to the fourth gray image based on the initial time, the first reference time, and a tenth time at which the fourth gray image has been obtained, recognize an eleventh response time taken for the second gray image to change to the fifth gray image based on the initial time, the first reference time, and an eleventh time at which the fifth gray image has been obtained, and recognize a twelfth response time taken for the second gray image to change to the sixth gray image based on the initial time, the first reference time, and a twelfth time at which the sixth gray image has been obtained.

In this way, the first controller 240 may recognize a response time of each gray value, taken for an initial gray value to change to a changed gray value. The first controller 240 may obtain a response time of each gray value, taken for an initial gray value to change to a changed gray value, as a response time table.

Here, the gray value may include all gray values corresponding to bits of gray scale.

The gray value may include some gray values selected from among all the gray values corresponding to the bits of gray scale.

The first controller 240 may recognize an average response time of the recognized response times and recognize a reference response time based on the recognized average response time.

The reference response time may be the average response time or a response time that is lower than the average response time by a predefined time. The predefined time may be a preset time.

The first controller 240 may receive a reference response time from the first input device 250.

The first controller 240 may recognize a reference response time range based on the reference response time. For example, the reference response time range may include a range from 0 to the reference response time.

For example, the first controller 240 may recognize a maximum response time among the recognized response times, recognize gray values corresponding to the recognized maximum response time, recognize a setting voltage of each of the recognized gray values, and correct the recognized setting voltage. This will be described as an example.

Referring to FIG. 11, the first controller 240 may correct all setting voltages of when a first gray value changes to other gray values. In this case, the first controller 240 may correct all the setting voltages of when the first gray value changes to the other gray values by raising the setting voltages by a predefined voltage.

As another example, the first controller 240 may recognize at least one response time that is longer than the reference response time among the recognized response times, recognize at least one gray value corresponding to the at least recognized response time, recognize a setting voltage of the recognized gray value, and correct the recognized setting voltage. This will be described as an example.

A case in which the reference response time is 1.4 ms will be described with reference to FIG. 11. The first controller 240 may recognize one or more response times of 5.2 ms, 5.6 ms, and 5.7 ms that are longer than the reference response time, recognize initial gray values and changed gray values of the respective recognized response times, recognize all setting voltages of the respective response times taken for the initial gray values to change to the changed gray values, and correct all the setting voltages.

The initial gray values may include the first gray value, and the changed gray values may include the second gray value, the third gray value, the fourth gray value, the fifth gray value, and the sixth gray value. In this case, the first controller 240 may correct all setting voltage of when the first gray value changes to other gray values by raising the setting values by a predefined voltage.

As another example, the first controller 240 may recognize a plurality of response times that are shorter than the reference response time among the recognized response times, recognize at least one response time having a smallest difference from the reference response time from among the plurality of recognized response times, recognize at least one gray value corresponding to the at least one response time, recognize a setting voltage of the recognized gray value, and correct the recognized setting voltage. This will be described as an example.

A case in which the reference response time is 1.4 ms will be described with reference to FIG. 11. The first controller 240 may recognize a plurality of response times of 0.5 ms, 0.6 ms, and 0.7 ms that are shorter than the reference response time, recognize the response time of 0.7 ms having a smallest difference from the reference response time from among the recognized response times, recognize an initial gray value and a changed gray value corresponding to the recognized response time of 0.7 ms, recognize a setting voltage of when the initial gray value changes to the changed gray value, and correct the recognized setting voltage.

Because the initial gray value is greater than the changed gray value, the first controller 240 may perform falling overdrive control corresponding to a decrease of a gray value. That is, the first controller 240 may correct the recognized setting voltage by lowering the setting voltage by a predefined voltage.

While the first controller 240 performs rising overdrive control corresponding to an increase of a gray value, the first controller 240 may correct a setting voltage of a recognized gray value by raising the setting voltage by a predefined voltage.

While the first controller 240 performs falling overdrive control corresponding to a decrease of a gray value, the first controller 240 may correct a setting voltage of a recognized gray value by lowering the setting voltage by a predefined voltage.

The first controller 240 may correct a setting voltage of at least one gray value to a corrected setting voltage in the original overdrive table, thereby correcting the overdrive table.

The first controller 240 may identify whether the recognized response times are included in the reference response time range.

According to at least one of the recognized response times deviating from the reference response time range, the first controller 240 may repeatedly perform a process of correcting a setting voltage of at least one gray value, then recognizing a response time taken for an initial gray value to change to a changed gray value, and again correcting the setting voltage of the at least one gray value based on the recognized response time and the reference response time range.

Here, the reference response time range may change depending on the recognized response times.

The first controller 240 may repeatedly perform a process of correcting the overdrive table, based on at least one of the recognized response times deviating from the reference response time range.

Based on all of the recognized response times being included in the reference response time range, the first controller 240 may terminate primary correction of the overdrive table.

### Secondary Correction of the Overdrive Table

The first controller 240 may recognize image quality of an image based on a second analyzed image received from the second image sensor 220.

The first controller 240 may recognize the image quality of the image based on the second analyzed image received in real time from the second image sensor 220.

The first controller 240 may recognize a change of a plurality of block images based on the second analyzed image received in real time, and identify whether the image quality of the image is in a normal state or in an abnormal state based on the recognized change of the plurality of block images.

The change of the plurality of block images may include a change of a plurality of text images in a plurality of background images.

The image quality of the image may include at least one of afterimages, reverse afterimages, or color fringing. The color fringing may include a state in which a different color from a target color is displayed.

The first controller 240 may recognize the image quality of the image by using a prestored image analysis program.

The first controller 240 may recognize the image quality to be in an abnormal state based on at least one of afterimages, reverse afterimages, or color fringing being recognized in the plurality of block images.

As shown in FIG. 12, the first controller 240 may recognize, based on recognition of color fringing, color fringing block images S1 and S2 from which color fringing has been recognized, recognize, based on recognition of reverse afterimages, afterimages block images S3 and S4 from which reverse afterimages have been recognized, and recognize, based on recognition of afterimages, afterimages block images S5 and S6 from which afterimages have been recognized.

The first controller 240 may recognize gray values of a background image and a text image of each of the recognized color fringing block images S1 and S2, recognize a setting voltage corresponding to a change from the gray value of the background image to the gray value of the text image, and correct the recognized setting voltage.

The first controller 240 may recognize gray values of a background image and a text image of each of the recognized reverse afterimages block images S3 and S4, and correct a setting value by raising the setting voltage by a predefined voltage based on the gray value of the background image and the gray value of the text image.

The first controller 240 may perform control of raising a setting voltage corresponding to falling overdrive control based on recognition of reverse afterimages.

The falling overdrive control may include control of lowering a voltage to change a gray value to a smaller gray value.

Reverse afterimages may occur when a voltage of the liquid crystal portion 125 reaches a target voltage early due to a high setting voltage during falling overdrive control.

That is, the first controller 240 may recognize a relatively greater gray value and a relatively smaller gray value between a gray value of a text image and a gray value of a background image, recognize a setting voltage of when the greater gray value changes to the smaller gray value, and correct the recognized setting voltage by raising the setting voltage by a predefined voltage.

The first controller 240 may recognize a gray value of a background image and a gray value of a text image of an afterimages block image, and correct a setting voltage by raising the setting voltage by a predefined voltage based on the gray value of the background image and the gray value of the text image.

The first controller 240 may perform control of increasing a setting voltage corresponding to rising overdrive control based on recognition of afterimages.

The rising overdrive control may include control of raising a voltage to change a gray value to a greater gray value.

Afterimages may occur when a voltage of the liquid crystal portion 125 reaches a target voltage late due to a low setting voltage.

That is, the first controller 240 may recognize a relatively greater gray value and a relatively smaller gray value between a gray value of a text image and a gray value of a background image, recognize a setting voltage of when the smaller gray value changes to the greater gray value, and correct the setting voltage by raising the setting voltage by a predefined voltage.

The first controller 240 may secondarily correct the primarily corrected overdrive table based on recognition of at least one of afterimages, reverse afterimages, or color fringing in the plurality of block images.

The first controller 240 may repeatedly secondarily correct the overdrive table until none of afterimages, reverse afterimages, and color fringing is recognized in the plurality of block images.

Based on afterimages, reverse afterimages, or color fringing being not recognized in the plurality of block images, the first controller 240 may identify that the image quality of the image is in a normal state and terminate secondary correction of the overdrive table.

Hereinafter, another example of determining correction of the overdrive table based on recognition of color fringing, afterimages, or reverse afterimages will be described.

The first controller 240 may recognize a color of a text image in each of the color fringing block images S1 and S2 from which color fringing has been recognized, recognize a difference between the recognized color and a color of the text image to be actually displayed, and determine whether to correct the overdrive table with respect to color fringing based on the recognized difference.

For example, the first controller 240 may recognize color information corresponding to the recognized color based on preset color standard information, recognize a color fringing ratio based on the recognized color information and color information of the text image to be actually displayed, and correct the overdrive table based on the recognized color fringing ratio exceeding a first reference ratio or maintain the overdrive table based on the recognized color fringing ratio being less than or equal to the first reference ratio.

The first controller 240 may recognize, based on the recognized color fringing ratio being less than or equal to the first reference ratio, the color fringing block image as a block image in a normal state.

As shown in FIG. 13, the first controller 240 may recognize an actual text image and a reverse afterimages text image in each of the recognized reverse afterimages block images S3 and S4, recognize a ratio (x %) of the reverse afterimages text image to the actual text image, and correct the overdrive table based on the recognized ratio (x %) exceeding a second reference ratio or maintain the overdrive table based on the recognized ratio (x %) being less than or equal to the second reference ratio.

For example, recognizing the ratio (x %) of the reverse afterimages text image to the actual text image may include recognizing a ratio of an area occupied by the reverse afterimages text image in the background image to an area occupied by the actual text image in the background image.

The first controller 240 may recognize, based on the recognized ratio being less than or equal to the second reference ratio, the reverse afterimages block image as a block image in a normal state.

The first controller 240 may recognize an actual text image and an afterimages text image in each of the recognized afterimages block images S5 and S6, recognize a ratio of the afterimages text image to the actual text image, and correct the overdrive table based on the recognized ratio exceeding a third reference ratio or maintain the overdrive table based on the recognized ratio being less than or equal to the third reference ratio.

For example, recognizing the ratio of the afterimages text image to the actual text image may include recognizing a ratio of an area occupied by the afterimages text image in the background image to an area occupied by the actual text image in the background image.

The first controller 240 may recognize, based on the recognized ratio being less than or equal to the third reference ratio, the afterimages block image as a block image in a normal state.

The first, second, and third reference ratios may be equal to or different from each other.

The first controller 240 may include at least one first processor 241 that controls operations of the analysis apparatus 200, and at least one first memory 242 that stores programs and data for controlling operations of the analysis apparatus 200.

The at least one first processor 241 may include at least one memory that stores algorithms and data in the form of programs for controlling operations of components in the analysis apparatus 200, and one or more processor chips or processing cores that perform the above-described operations by using data stored in the at least one memory.

The at least one first processor 241 may process various data and various signals by using instructions, data, programs, and/or software stored in the first memory 242.

The at least one first processor 241 may include one or more of a Central Processing Unit (CPU), a Graphics Processing Unit (GPU), an Accelerated Processing Unit (APU), a Many Integrated Core (MIC), a Digital Signal Processor (DSP), an Neural Processing Unit (NPU), a hardware accelerator, or a machine learning accelerator.

The first memory 242 may store an original overdrive table received from the display apparatus 100.

The first memory 242 may store a primarily corrected overdrive table.

The first memory 242 may store a secondarily corrected overdrive table.

The first memory 242 may store an original overdrive table corresponding to identification information of the display apparatus 100.

The first memory 242 may store standard image quality information based on which image quality of an image is recognized to be in a normal state.

The first memory 242 may store a first program for testing a response speed of the liquid crystals.

The first memory 242 may store a second program for testing image quality of an image. For example, the second program for testing image quality of an image may include a program for checking afterimages of an image.

The first memory 242 may store a third program for analyzing image quality of an image.

The third program may be a program using artificial intelligence.

The first memory 242 may store data required for various embodiments.

The first memory 242 may be implemented in the form of memory embedded into the analysis apparatus 200 or in the form of memory that is attached to or detached from the analysis apparatus 200, depending on purposes of data storage. For example, data for operating the analysis apparatus 200 may be stored in memory embedded into the analysis apparatus 200 and data for an expansion function of the analysis apparatus 200 may be stored in memory that is attached to or detached from the analysis apparatus 200.

Meanwhile, the memory embedded into the analysis apparatus 200 may be implemented as at least one of volatile memory (e.g., dynamic RAM (DRAM), static RAM (SRAM), or synchronous dynamic RAM (SDRAM)) or non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash), hard drive, or solid state drive (SSD)).

Also, the memory that is attached to or detached from the analysis apparatus 200 may be implemented in the form of a memory card (e.g., compact flash (CF), secure digital (SD), micro secure digital (Micro-SD), mini secure digital (Mini-SD), extreme digital (xD), multi-media card (MMC), etc.), external memory (for example, USB memory) capable of being connected to a USB port, etc., but the present disclosure is not limited thereto.

The first memory 242 may include one or more memory chips or one or more memory blocks.

The first input device 250 may receive a user input. Here, the user input may include a manager's input, an analyst's input, etc.

The first input device 250 may receive a transmission command for the first or second program.

The first input device 250 may include an execution command for the first or second program. Also, the first input device 250 may receive a display command for the first or second test image.

The first input device 250 may receive an analysis start command, an analysis end command, etc. for the display apparatus 100.

The first input device 250 may receive identification information of the display apparatus 100.

The first input device 250 may include a hardware device, such as various buttons or switches, a pedal, a keyboard, a mouse, a track-ball, various levers, a handle, a stick, and the like.

Also, the first input device 250 may include a Graphic User Interface (GUI) such as a touch pad, that is, a software device. The touch pad may be implemented as a Touch Screen Panel (TSP) and form a multilayer structure with the display apparatus 100.

The first input device 250 may be configured as a touch screen panel (TSP) forming a multilayer structure with a touch pad.

The display 260 may display analysis result information of the display apparatus 100 and analysis progress information.

The display 260 may display transmission information of the overdrive table of the display apparatus 100 or identification information of the display apparatus 100.

The display 260 may include, but is not limited to, a cathode ray tube (CRT), a digital light processing (DLP) panel, a plasma display panel, a liquid crystal display (LCD) panel, an electroluminescence (EL) panel, an electrophoretic display (EPD) panel, an electrochromic display (ECD) panel, a light emitting diode (LED) panel, or an organic light emitting diode (OLED) panel.

A function related to artificial intelligence according to the present disclosure may operate through a processor and memory. The processor may be configured as a single processor or a plurality of processors. In this case, the single processor or each of the plurality of processors may be a general-purpose processor, such as CPU, AP, and Digital Signal Processor (DSP), a graphic-dedicated processor, such as GPU and Vision Processing Unit (VPU), or an artificial intelligence dedicated processor such as NPU. The single processor or the plurality of processors may perform a control operation of processing input data according to a predefined operation rule or artificial intelligence model stored in the memory. Also, when the single processor or each of the plurality of processors is an artificial intelligence-dedicated processor, the artificial intelligence-dedicated processor may be designed as a specialized hardware structure for processing a specific artificial intelligence model.

The predefined operation rule or artificial intelligence model may be generated through training. Generating the predefined operation rule or artificial intelligence model through training means generating a predefined operation rule or artificial intelligent model set to perform a desired characteristic (or a purpose) when a basic artificial intelligence model is trained with a plurality of pieces of training data by a learning algorithm. The training may be performed by an apparatus for performing artificial intelligence according to the present disclosure or by a separate server and/or system. The learning algorithm may include, but is not limited to, supervised learning, unsupervised learning, semi-supervised learning, or reinforcement learning.

The artificial intelligence model may be configured with a plurality of neural network layers. Each of the plurality of neural network layers may have a plurality of weights, and perform a neural network arithmetic operation through an arithmetic operation between an arithmetic operation result of a previous layer and the plurality of weights. The plurality of weights of the plurality of neural network layers may be optimized by a training result of the artificial intelligence model. For example, the plurality of weights may be updated such that a loss value or a cost value obtained by the artificial intelligence model during a training process is reduced or minimized. An artificial neural network may include a deep neural network (DNN), and the artificial neural network may include, but is not limited to, for example, a convolutional neural network (CNN), a deep neural network (DNN), a recurrent neural network (RNN), a restricted boltzmann machine (RBM), a deep belief network (DBN), a bidirectional recurrent deep neural network (BRDNN), or Deep Q-Networks, although not limited to the above-mentioned examples.

At least one component may be added or omitted to correspond to performance of the components of the analysis apparatus 200 shown in FIG. 6. Also, relative positions of the components may change according to the performance or structure of the system, which will be easily understood by one of ordinary skill in the art.

Meanwhile, the components shown in FIG. 6 may be a software and/or hardware component such as a Field Programmable Gate Array (FPGA) or an Application Specific Integrated Circuit (ASIC).

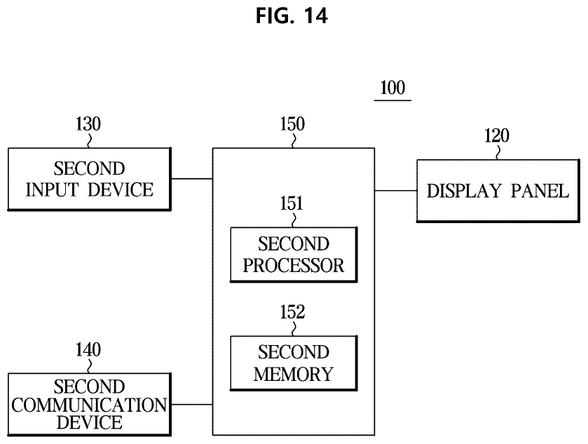

FIG. 14 is a control configuration diagram of a display apparatus according to an embodiment.

The display apparatus 100 may include the display panel 120, a second input device 130, a second communication device 140, and a second controller 150.

The display panel 120 may display an image based on a control command from the second controller 150.

For example, the display panel 120 may display a first test image for recognizing a response time or a second test image for recognizing image quality.

The display panel 120 may include a liquid crystal display panel. The display panel 120 has been described with reference to FIG. 2, and, therefore, descriptions thereof will be omitted.

The second input device 130 may receive a user input. Here, the user input may include a manager's input, an analyst's input, etc.

The second input device 130 may receive a communication connection command and a communication termination command for the analysis apparatus 200.

The second input device 130 may receive a correction start command and a correction end command for an overdrive table.

The second input device 130 may receive an execution command for at least one of the first or second program.

The second input device 130 may receive a display command for the first or second test image.

The second input device 130 may receive a power on/off command.

The second input device 130 may include a hardware device, such as various buttons or switches, a pedal, a keyboard, a mouse, a track-ball, various levers, a handle, a stick, and the like.

The second input device 130 may include a GUI such as a touch pad, that is, a software device. The touch pad may be implemented as a TSP and form a multilayer structure with the display apparatus 100.

The second input device 130 may be configured as a TSP forming a multilayer structure with a touch pad.

The second communication device 140 may perform communication between internal components of the display apparatus 100 or communicate with the analysis apparatus 200.

The second communication device 140 may receive a display command for the first test image and a display command for the second test image from the analysis apparatus 200, and transmit the display command for the first test image and the display command for the second test image to the second controller 150.

The second communication device 140 may transmit, based on request information for identification information of the display apparatus 100 being received from the analysis apparatus 200, the identification information of the display apparatus 100 to the analysis apparatus 200.

The second communication device 140 may transmit, based on a corrected overdrive table being received from the analysis apparatus 200, the corrected overdrive table to the second controller 150.

The second communication device 140 may transmit, based on at least one of the first or second program being received from the analysis apparatus 200, the at least one of the first or second program to the second controller 150.

The second communication device 140 may transmit, based on an execution command for at least one of the first or second program being received from the analysis apparatus 200, the execution command for at least one of the first or second program to the second controller 150.

The second communication device 140 may transmit information on an initial time which is a test start time to the analysis apparatus 200 based on a control command from the second controller 150.

The second communication device 140 may establish a direct (e.g., wired) communication channel or a wireless communication channel with the analysis apparatus 200 and support communication through the established communication channel.

The second communication device 140 may transmit specification information of the main chip or identification information of the main chip related to image display of the display apparatus 100 to the analysis apparatus 200.

The second communication device 140 may transmit information on an original overdrive table to the analysis apparatus 200.

The second communication device 140 may transmit information on a target voltage for each gray value to the analysis apparatus 200.

The second communication device 140 may transmit information on a minimum voltage of each gray value for rising overdrive control to the analysis apparatus 200 and transmit information on a maximum voltage of each gray value for falling overdrive control to the analysis apparatus 200.

A detailed example of the second communication device 140 may be the same as a detailed example of the first communication device 230, and therefore, descriptions thereof will be omitted.

The second controller 150 may be electrically connected to various components and/or devices of the display apparatus 100 and control the various components and/or devices. That is, the second controller 150 may control overall operations of the display apparatus 100.

The second controller 150 may control operations of the display apparatus 100 based on a user input received by the second input device 130.

The second controller 150 may control the display panel 120 to output output information related to operations of the display apparatus 100.

The second controller 150 may identify a connection to the analysis apparatus 200 and according to the second controller 150 identifying a connection to the analysis apparatus 200, the second controller 150 may control the second communication device 140 to transmit identification information of the display apparatus 100 to the analysis apparatus 200.

The connection to the analysis apparatus 200 may include a connection by wired communication and a connection by wireless communication.

Based on the second controller 150 identifying a connection to the analysis apparatus 200, the second controller 150 may control the second communication device 140 to transmit identification information of the main chip of the display apparatus 100 to the analysis apparatus 200.

According to the second controller 150 receiving a first program for testing a response speed of the liquid crystals, the second controller 150 may control storage of the received first program.

According to the second controller 150 receiving a second program for testing image quality of an image, the second controller 150 may control storage of the received second program.

At least one of the first or second program may have been stored in the second memory 152.

Based on the second controller 150 receiving an execution command for the first program from the analysis apparatus 200 or the second input device 130, the second controller 150 may control execution of the first program.

While the second controller 150 controls execution of the first program, the second controller 150 may control the display panel 120 to display a first test image.

Based on the second controller 150 receiving a display command for the first test image from the analysis apparatus 200 or the second input device 130, the second controller 150 may control the display panel 120 to display the first test image.

The first test image may be a plurality of gray images having different gray values and include a first gray image having a first gray value g1 to a n-th gray image having a n-th gray value gn, wherein n may be a number corresponding to bits of gray scale.

The first test image may include a gray image having a first gray value g1, a gray image having a n-th gray value gn, and a plurality of gray images having different gray values at reference ratio intervals from the first gray value g1 to the n-th gray value gn.

For example, the reference ratio may be, but is not limited to, about 5%, about 10%, or about 20%.

In a case where n is 256 and the reference ratio is 20%, the first test image may include the first gray image having the first gray value g1, a second gray image having a 51-st gray value, a third gray image having a 102-nd gray value, a fourth gray image having a 153-rd gray value, a fifth gray image having a 204-th gray value, and a sixth gray image having a 256-th gray value g256.

The first test image may include the gray image having a first gray value g1, the gray image having an n-th gray value gn, and a plurality of gray images having different gray values at reference multiple intervals between the first gray value g1 and the n-th gray value gn.

For example, the reference multiple may be, but is not limited to, 8, 16, 32, or 64.

In a case where n is 256 and the reference multiple is 32, the first test image may include the first gray image having the first gray value g1, a second gray image having a 32-nd gray value, a fourth gray image having a 64-th gray value, a fifth gray image having a 96-th gray value, a sixth gray image having a 128-th gray value, a seventh gray image having a 160-th gray value, an eighth gray image having a 192-nd gray value, a ninth gray image having a 224-th gray value, and a tenth gray image having a 256-th gray value.

The first test image may include a gray image of which a gray value changes at first reference time intervals. The first reference time may be a time for which a currently displayed gray image is maintained or a time for recognizing a time at which a voltage is applied to display a gray image of which a gray value has changed.

For example, the display apparatus 100 may apply a first setting voltage and a first target voltage sequentially to the liquid crystal portion 125 to display a gray image having a first gray value at a test start time, apply, when the first reference time has elapsed from a time at which the first setting voltage has been applied to the liquid crystal portion 125, a second setting voltage and a second target voltage sequentially to the liquid crystal portion 125 to display a gray image having a second gray value, and apply, when the first reference time has elapsed from a time at which the second setting voltage has been applied to the liquid crystal portion 125, a third setting voltage and a fourth target voltage sequentially to the liquid crystal portion 125 to display a gray image having a third gray value.

The test start time may be a time at which a voltage starts being applied to the liquid crystal portion 125 to display the gray image having the first gray value.

The second controller 150 may control the display panel 120 to sequentially display a plurality of gray images having different gray values.

After all of the plurality of gray images having different gray values are displayed, the second controller 150 may terminate the first program.

After all of the plurality of gray images having the different gray values are displayed, the second controller 150 may terminate control of displaying the first test image.

Based on the second controller 150 receiving an execution command for the second program from the analysis apparatus 200 or the second input device 130, the second controller 150 may control execution of the second program.

While the second controller 150 controls execution of the second program, the second controller 150 may control the display panel 120 to display a second test image.

Based on the second controller 150 receiving a display command for a second test image from the analysis apparatus 200 or the second input device 130, the second controller 150 may control the display panel 120 to display the second test image.

The second controller 150 may control the display panel 120 to display the second test image in real time.

For example, the second controller 150 may control the display panel 120 to display a first block image bm1, and when a second reference time has elapsed, the second controller 150 may control the display panel 120 to display a second block image bm2.

The first block image bm1 may include n background images gb1 corresponding to bits of gray scale, and n text images gt1 displayed in the n background images gb1.

The second block image bm2 may include n background images gb1, and n text images gt2 displayed in the n background images gb1.

In the first and second block images bm1 and bm2, background images in the same row may have the same gray value, and background images in different rows may have different gray values.

In the first and second block images bm1 and bm2, text images in the same columns may have the same gray value, and text images in different columns may have different gray values.

The second block image bm2 displayed on the display apparatus 100 may be an image in which all text images gt1 in the first block image bm1 displayed on the display apparatus 100 have moved to the left columns.

After all block images are displayed, the second controller 150 may terminate the second program.

According to the second controller 150 receiving a corrected overdrive table from the second communication device 140, the second controller 150 may update the original overdrive table stored in the second memory 152 to the corrected overdrive table.

The second controller 150 may control a voltage that is applied to the liquid crystal portion 125, based on the updated overdrive table. Controlling a voltage that is applied to the liquid crystal portion 125 may include controlling an electric field in the liquid crystal portion 125. Controlling a voltage that is applied to the liquid crystal portion 125 may include controlling a voltage that is applied to the first and second electrode portions 123 and 124.

A case of increasing a gray value of the liquid crystal portion 125 from a first gray value to a second gray value will be described. Here, the first gray value may be an initial gray value, and the second gray value may be a changed gray value.

It is assumed that a first target voltage and a first setting voltage corresponding to the first gray value have been stored and a second target voltage and a second setting voltage corresponding to the second gray value have been stored.

The second controller 150 may control a voltage applied to the liquid crystal portion 125 to rise from the first target voltage up to the second setting voltage, and when the voltage applied to the liquid crystal portion 125 reaches the second setting voltage, the second controller 150 may control the voltage applied to the liquid crystal portion 125 to fall to the second target voltage. When the voltage applied to the liquid crystal portion 125 reaches the second target voltage, the second controller 150 may control the voltage applied to the liquid crystal portion 125 to be maintained at the second target voltage.

The second setting voltage may be a voltage stored in the overdrive table.

The second setting voltage may be a voltage for reducing a response time upon a change from the first gray value to the second gray value, and may be higher than the second target voltage.

The following descriptions will be provided under an assumption that a second target voltage, a second setting voltage, a second maximum voltage, and a second minimum voltage corresponding to the second gray value have been stored and a first target voltage, a second setting voltage, a first minimum voltage, and a first maximum voltage corresponding to the first gray value have been stored.

The second controller 150 may control a voltage applied to the liquid crystal portion 125 to rise from the first target voltage up to the second setting voltage, and when the voltage applied to the liquid crystal portion 125 reaches the second setting voltage, the second controller 150 may control the voltage applied to the liquid crystal portion 125 to fall to the second minimum voltage. When the voltage applied to the liquid crystal portion 125 reaches the second minimum voltage, the second controller 150 may control the voltage applied to the liquid crystal portion 125 to rise up to the second target voltage, and when the voltage applied to the liquid crystal portion 125 reaches the second target voltage, the second controller 150 may control the voltage applied to the liquid crystal portion 125 to be maintained at the second target voltage.

A case of decreasing a gray value of the liquid crystal portion 125 from a fourth gray value to a third gray value will be described.

The following descriptions will be given under an assumption that a fourth target voltage and a fourth setting voltage corresponding to the fourth gray value have been stored and a third target voltage and a third setting voltage corresponding to the third gray value have been stored.

For example, the second controller 150 may control a voltage applied to the liquid crystal portion 125 to fall from the fourth target voltage to the third setting voltage, and when the voltage applied to the liquid crystal portion 125 reaches the third setting voltage, the second controller 150 may control the voltage applied to the liquid crystal portion 125 to fall to the third target voltage. When the voltage applied to the liquid crystal portion 125 reaches the third target voltage, the second controller 150 may control the voltage applied to the liquid crystal portion 125 to be maintained at the third target voltage.

The third setting voltage may be a voltage stored in the overdrive table.

The third setting voltage may be a voltage for reducing a response time upon a change from the fourth gray value to the third gray value, and may be lower than the third target voltage.

The following descriptions will be given under an assumption that a fourth target voltage, a fourth setting voltage, a fourth maximum voltage, and a fourth minimum voltage corresponding to the fourth gray value have been stored, and a third target voltage, a third minimum voltage, and a third maximum voltage corresponding to the third gray value have been stored.

As another example, the second controller 150 may control a voltage applied to the liquid crystal portion 125 to fall from the fourth target voltage to the third setting voltage, and when the voltage applied to the liquid crystal portion 125 reaches the third setting voltage, the second controller 150 may control the voltage applied to the liquid crystal portion 125 to rise up to the third maximum voltage. When the voltage applied to the liquid crystal portion 125 reaches the third maximum voltage, the second controller 150 may control the voltage applied to the liquid crystal portion 125 to fall to the third target voltage, and when the voltage applied to the liquid crystal portion 125 reaches the third target voltage, the second controller 150 may control the voltage applied to the liquid crystal portion 125 to be maintained at the third target voltage.

That is, when the second controller 150 increases an initial gray value to a changed gray value, the second controller 150 may recognize a setting voltage for changing the initial gray value to the changed gray value from the overdrive table, recognize a target voltage corresponding to the changed gray value, control a voltage applied to the liquid crystal portion 125 to rise up to the recognized setting voltage, and then control the voltage applied to the liquid crystal portion 125 to fall to the recognized target voltage.

When the second controller 150 decreases an initial gray value to a changed gray value, the second controller 150 may recognize a setting voltage for changing the initial gray value to the changed gray value from the overdrive table, recognize a target voltage corresponding to the changed gray value, control the voltage applied to the liquid crystal portion 125 to fall to the recognized setting voltage, and then raise the voltage applied to the liquid crystal portion 125 up to the recognized target voltage.

Whenever the second controller 150 receives a corrected overdrive table and a display command for a first test image from the analysis apparatus 200, the second controller 150 may correct a stored overdrive table to the corrected overdrive table and control the display panel 120 to display the first test image based on the corrected overdrive table.

Whenever the second controller 150 receives a corrected overdrive table and a display command for a second test image from the analysis apparatus 200, the second controller 150 may correct a stored overdrive table to the corrected overdrive table and control the display panel 120 to display the second test image based on the corrected overdrive table.

According to the second controller 150 receiving a finally corrected overdrive table from the analysis apparatus 200, the second controller 150 may finally correct an overdrive table stored in the second memory 152 based on the finally corrected overdrive table.

Based on an external memory device such as a USB being connected to the second controller 150, the second controller 150 may receive a corrected overdrive table from the external memory device and update an original overdrive table stored in the second memory 152 by using the received overdrive table.

In this case, the external memory device may receive the corrected overdrive table from the analysis apparatus 200, store the corrected overdrive table therein, and transmit the corrected overdrive table to the display apparatus 100.

The second controller 150 may include at least one second processor 151 that controls operations of the display apparatus 100, and at least one second memory 152 that stores programs and data for controlling operations of the display apparatus 100.

The at least one second processor 151 may include at least one memory that stores algorithms and data in the form of programs for controlling operations of components in the display apparatus 100, and one or more processor chips or processing cores that perform the above-described operations by using data stored in the at least one memory.

The at least one second processor 151 may process various data and various signals by using instructions, data, programs, and/or software stored in the second memory 152.

The at least one second processor 151 may include one or more of a CPU, a GPU, an APU, a MIC, a DSP, an NPU, a hardware accelerator, or a machine learning accelerator.

The second memory 152 may store an original overdrive table.

The original overdrive table may include information on a setting voltage for changing each initial gray value to a changed gray value.

The second memory 152 may store the updated overdrive table.

The second memory 152 may store identification information of the display apparatus 100.

The second memory 152 may store information on a target voltage for each gray value.

The second memory 152 may store information on a maximum voltage and a minimum voltage for each gray value.

The second memory 152 may store a first program for testing a response speed of the liquid crystals.

The second memory 152 may store a second program for testing image quality of an image. For example, the second program for testing the image quality of the image may include a program for checking afterimages of an image.

The second memory 152 may store data required for various embodiments.

The second memory 152 may be implemented in the form of memory embedded into the display apparatus 100 or in the form of memory that is attached to or detached from the display apparatus 100, depending on purposes of data storage. For example, data for operating the display apparatus 100 may be stored in memory embedded into the display apparatus 100 and data for an expansion function of the display apparatus 100 may be stored in memory that is attached to or detached from the display apparatus 100.

Meanwhile, the memory embedded into the display apparatus 100 may be implemented as at least one of volatile memory (e.g., DRAM, SRAM, or SDRAM) or non-volatile memory (e.g., OTPROM, PROM, EPROM, EEPROM, mask ROM, flash ROM, flash memory (e.g., NAND flash or NOR flash), hard drive, or SSD).

Also, the memory that is attached to or detached from the display apparatus 100 may be implemented in the form of a memory card (e.g., CF, SD, Micro-SD, Mini-SD, xD, MMC, etc.), external memory (e.g., USB memory) capable of being connected to a USB port etc., but the present disclosure is not limited thereto.

The second memory 152 may include one or more memory chips or one or more memory blocks.

At least one component may be added or omitted to correspond to performance of the components of the display apparatus 100 shown in FIG. 14. Also, relative positions of the components may change according to the performance or structure of the system, which will be easily understood by one of ordinary skill in the art.

Meanwhile, the components shown in FIG. 14 may be a software and/or hardware component such as a FPGA or an ASIC.

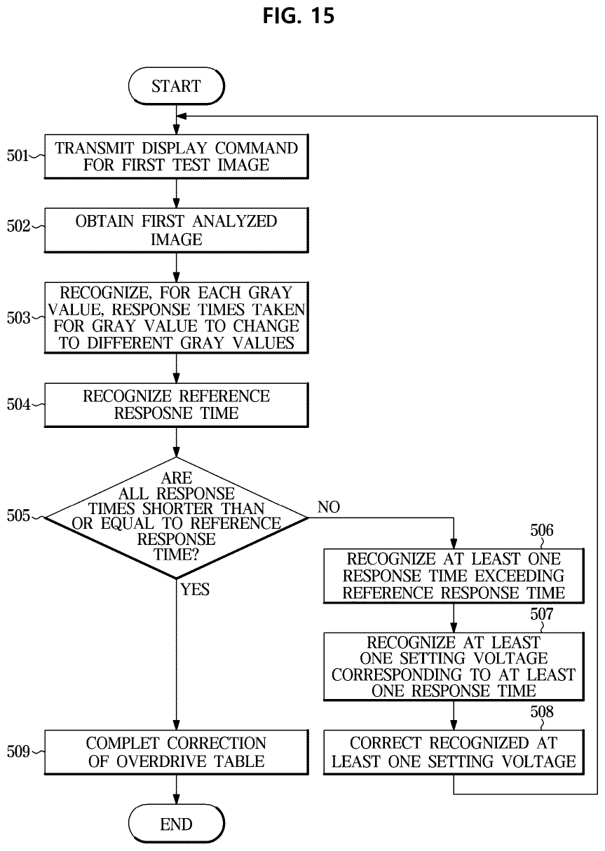

FIG. 15 is a control flowchart of an analysis apparatus for primarily correcting an overdrive table of a display apparatus according to an embodiment.

The analysis apparatus may transmit request information for requesting identification information of the display apparatus 100 to the display apparatus, and according to the analysis apparatus receiving identification information of the display apparatus, the analysis apparatus may recognize an overdrive table provided in the display apparatus from a server or the first memory.

The analysis apparatus may transmit request information for requesting an overdrive table to the display apparatus and receive an overdrive table of the display apparatus from the display apparatus.

The display apparatus may transmit a display command for a first test image to the display apparatus (501).

Transmitting the display command for the first test image may include transmitting an execution command for a first program.

According to display control information of the first test image being received from the display apparatus, the analysis apparatus may obtain a first analyzed image for the first test image displayed on the display apparatus by using the first image sensor 210 (502). The analysis apparatus may obtain the first analyzed image in real time.

The analysis apparatus may receive information on an initial time at which a test starts from the display apparatus.

The analysis apparatus may recognize, for each gray value, a response time taken for a gray image having one gray value to change to another gray image having another gray value, based on the initial time, a first reference time, and the obtained first analyzed image (503).

The other gray value may be greater or smaller than the one gray value.

The analysis apparatus may receive the information on the initial time at which the test starts from the display apparatus.

For example, the analysis apparatus may recognize a first response time taken for a first gray image to be displayed based on the initial time and a time at which the first gray image has been recognized, a second response time taken for the first gray image to change to a second gray image based on the initial time, the first reference time, and a time at which the second gray image has been recognized, and recognize a third response time taken for the second gray image to change to a third gray image based on the initial time, the first reference time, and a time at which the third gray image has been recognized.

In this way, the analysis apparatus may obtain a response time table about response times for each gray value.

The analysis apparatus may recognize an average response time for the response times and recognize a reference response time based on the average response time (504).

Here, the reference response time may be the average response time or a response time that is lower than the average response time by a predefined time, wherein the predefined time may be a preset time.

The analysis apparatus may receive a reference response time from the first input device 250.

The analysis apparatus may recognize a reference response time range based on the reference response time. For example, the reference response time range may include a range from 0 to the reference response time.

The analysis apparatus may identify whether the recognized response times are shorter than or equal to the reference response time (505).

Identifying whether the recognized response times are shorter than or equal to the reference response time may include identifying whether response times in the response time table are shorter than or equal to the reference response time.

Based on at least one of the recognized response times being identified to exceed the reference response time, the analysis apparatus may recognize the at least one response time exceeding the reference response time among the recognized response times (506), recognize at least one setting voltage corresponding to the recognized at least one response time (507), and correct the recognized at least one setting voltage (508).

The analysis apparatus may recognize at least one response time that is longer than the reference response time among the recognized response times, recognize at least one initial gray value and at least one changed gray value corresponding to the recognized at least one response time, recognize a setting voltage of when the at least one initial gray value changes to the at least one changed gray value, and correct the setting voltage.

For example, a case in which the reference response time is 1.4 ms will be described with reference to FIG. 13. The analysis apparatus may recognize at least one response time of 5.2 ms, 5.6 ms, and 5.7 ms, which is longer than the reference response time, recognize a gray value a and a gray value b for each recognized response time, recognize all setting voltages for each response time taken for an initial gray value to change to a changed gray value, and correct all the setting voltages.

The initial gray value may be a first gray value, and the changed gray value may include a second gray value, a third gray value, a fourth gray value, a fifth gray value, and a sixth gray value. At this time, the analysis apparatus may correct all the setting values of when the initial gray value changes to the changed gray values by raising the setting voltages by a preset voltage.

As another example, the analysis apparatus may recognize a plurality of response times that are shorter than the reference response time among the recognized response times, recognize at least one response time having a smallest difference from the reference response time among the plurality of response times, recognize at least one initial gray value and at least one changed gray value corresponding to the recognized at least one response time, recognize a setting value corresponding to the at least one initial gray value and the at least one changed gray value, and correct the recognized setting voltage.

For example, a case in which the reference response time is 1.4 ms will be described with reference to FIG. 11. The analysis apparatus may recognize a plurality of response times of 0.5 ms, 0.6 ms, and 0.7 ms, which are shorter than the reference response time, recognize the response time of 0.7 ms having a smallest difference from the reference response time among the recognized response times, recognize an initial gray value and a changed gray value corresponding to the recognized response time of 0.7 ms, recognize a setting voltage of when the initial gray value changes to the changed gray value, and correct the recognized setting voltage.

Because the initial gray value is greater than the changed gray value, the analysis apparatus may perform falling overdrive control corresponding to a decrease of a gray value. That is, the analysis apparatus may correct the recognized setting voltage by lowering the setting voltage by a preset voltage.

As another example, the analysis apparatus may recognize a maximum response time among the recognized response times, recognize an initial gray value and a changed gray value corresponding to the recognized maximum response time, recognize a setting voltage for the initial gray value and changed gray value, and correct the recognized setting voltage.

Whenever the analysis apparatus corrects an overdrive table based on a response time, the analysis apparatus may transmit the corrected overdrive table to the display apparatus and transmit a display command for a first test image through the corrected overdrive table to the display apparatus.

The analysis apparatus may repeatedly perform a process of, according to display control information for a first test image being received from the display apparatus, obtaining a first analyzed image and correcting at least one setting voltage in the overdrive table based on the obtained first analyzed image, until all of the recognized response times become shorter than the reference response time.

That is, the analysis apparatus may repeatedly correct at least one setting voltage until all of the recognized response times become shorter than the reference response time.

Based on all of the recognized response times becoming shorter than the reference response time, the analysis apparatus may complete correction of the overdrive table by completing correction of at least one setting voltage (509).

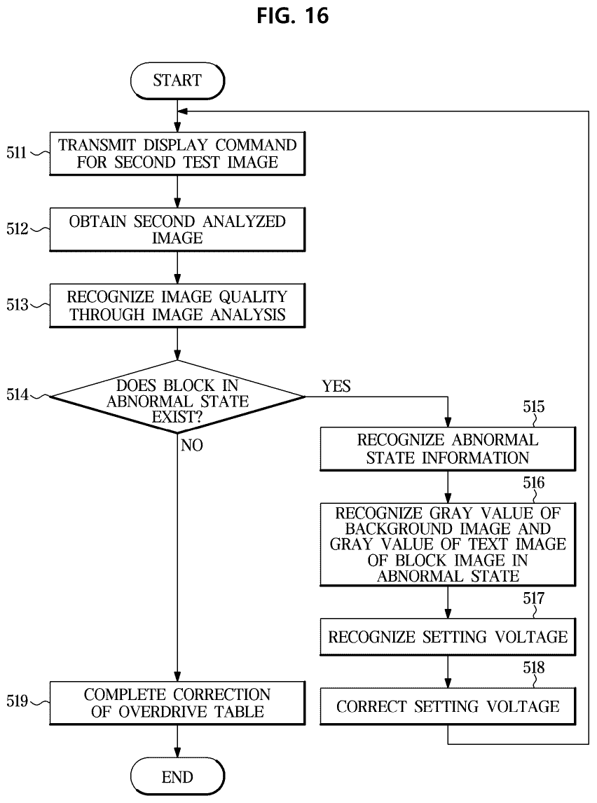

FIG. 16 is a control flowchart of an analysis apparatus for secondarily correcting an overdrive table of a display apparatus according to an embodiment.

The analysis apparatus may transmit a display command for a second test image to the display apparatus (511).

Transmitting the display command for the second test image may include transmitting an execution command for a second program.

According to the display control information for the second test image being received from the display apparatus, the analysis apparatus may obtain a second test image displayed on the display apparatus as a second analyzed image by using the second image sensor 220 (512).

The analysis apparatus may analyze the second analyzed image received in real time from the second image sensor 220 by using artificial intelligence and recognize image quality of the image based on the analyzed result (513).

Recognizing the image quality of the image may include identifying whether the image quality of the image is in a normal state or in an abnormal state.

More specifically, while the analysis apparatus analyzes the second analyzed image received in real time, the analysis apparatus may recognize a change of a plurality of block images displayed on the display apparatus and identify whether the image quality of the image is in a normal state or in an abnormal state based on the recognized change of the plurality of block images.

Recognizing the change of the plurality of block images may include recognizing a change of a text image in the plurality of block images.

Recognizing the change of the plurality of block images may include identifying whether at least one of color fringing, reverse afterimages, or afterimages has occurred in at least one block image when a text image in the plurality of block images changes.

That is, the analysis apparatus may identify whether a block image in an abnormal state exists (514).

According to a block image in an abnormal state being identified to exist, the analysis apparatus may recognize at least one of color fringing, reverse afterimages, or afterimages, which has occurred in the block image in the abnormal state.

That is, the analysis apparatus may recognize abnormal state information for the block image in the abnormal state (515).

In a case where a plurality of block images are in an abnormal state, the analysis apparatus may recognize abnormal state information for each block image in an abnormal state.

The analysis apparatus may recognize a gray value of a background image and a gray value of a text image of the block image in the abnormal state (516).

The analysis apparatus may recognize a setting voltage based on the abnormal state information for the block image in the abnormal state, the gray value of the background image of the block image in the abnormal state, and the gray value of the text image (517), and correct the recognized setting voltage (518).

This will be described as an example with reference to FIG. 12.

The analysis apparatus may recognize, based on recognition of color fringing, color fringing recognized block images S1 and S2 from which color fringing has been recognized, recognize, based on recognition of reverse afterimages, reverse afterimages block images S3 and S4 from which reverse afterimages have been recognized, and recognize, based on recognition of afterimages, afterimages block images S5 and S6 from which afterimages have been recognized.

The analysis apparatus may recognize a gray value of a background image and a gray value of a text image of each recognized color fringing block image, recognize a setting voltage corresponding to a change from the gray value of the background image to the gray value of the text image, and correct the recognized setting voltage.

The analysis apparatus may recognize a gray value of a background image and a gray value of a text image of each recognized reverse afterimages block image and correct the setting voltage by raising the setting voltage by a preset voltage based on the gray value of the text image and the gray value of the background image.

More specifically, the analysis apparatus may recognize a relatively greater gray value and a relatively smaller gray value between the gray value of the text image and the gray value of the background image, recognize the relatively greater gray value as an initial gray value, recognize the relatively smaller gray value as a changed gray value, recognize a setting voltage corresponding to the initial gray value and the change gray value, and correct the recognized setting voltage by raising the setting voltage by the preset voltage.

The analysis apparatus may recognize a gray value of a background image and a gray value of a text image of each recognized afterimages block image and correct the setting voltage by raising the setting voltage by the preset voltage based on the gray value of the background image and the gray value of the text image.

More specifically, the analysis apparatus may recognize a relatively greater gray value and a relatively smaller gray value between the gray value of the text image and the gray value of the background image, recognize the relatively smaller gray value as an initial gray value, recognize the relatively greater gray value as a changed gray value, recognize a setting voltage of when the initial gray value changes to the changed gray value, and correct the recognized setting voltage by raising the setting voltage by the preset voltage.

The analysis apparatus may correct an overdrive table based on image quality.

Whenever the analysis apparatus corrects an overdrive table based on image quality, the analysis apparatus may transmit the corrected overdrive table to the display apparatus and transmit a display command for a second test image through the corrected overdrive table to the display apparatus.

The analysis apparatus may repeatedly perform a process of, according to display control information of a second test image being received from the display apparatus, obtaining a second analyzed image and correcting at least one setting voltage in the overdrive table based on the obtained second analyzed image, until image quality becomes a normal state.

The analysis apparatus may recognize the image quality to be in a normal state based on any of afterimages, reverse afterimages, or color tinges being not recognized in the plurality of block images, and complete correction of the overdrive table (519).

The analysis apparatus may transmit a finally corrected overdrive table to the display apparatus.

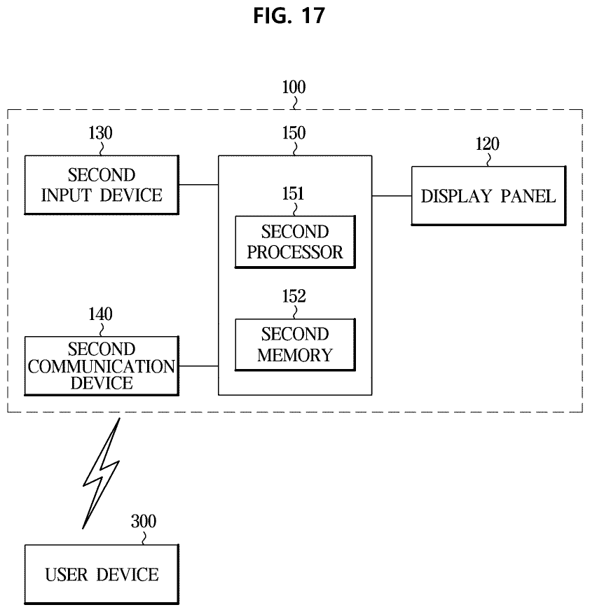

FIG. 17 is a control configuration diagram of a display apparatus according to another embodiment.

In order to use the same terms as those in an embodiment, the terms second and third programs and a second test image will be used instead of the first program and the first test image.

The display apparatus according to another embodiment may communicate with a user device 300.

The display apparatus according to another embodiment may include the display panel 120, the second input device 130, the second communication device 140, and the second controller 150.

The display panel 120 and the second input device 130 of the display apparatus according to another embodiment are the same as the display panel 120 and the second input device 130 of the display apparatus according to an embodiment, and therefore, descriptions thereof will be omitted.

The second communication device 140 may communicate with the user device 300.

In a case where a third program has been installed in the user device 300, the second communication device 140 may receive a corrected overdrive table from the user device 300 and transmit the received overdrive table to the second controller 160.

Here, the third program may be a program for analyzing image quality.

In a case where the third program has been installed in the user device 300, the second communication device 140 may transmit, based on request information for identification information of the display apparatus being received from the user device 300, the identification information of the display apparatus to the user device 300.

In a case where the third program has been installed in the display apparatus, not in the user device 300, the second communication device 140 may receive a second analyzed image from the user device 300 and transmit the received second analyzed image to the second controller 160.

The second communication device 140 may receive a display command for a second test image from the user device 300 and transmit the received display command for the second test image to the second controller 160.

The second communication device 140 may transmit, based on at least one of the second program and the third program being received from the user device 300, the at least one of the second program and the third program to the second controller 160.

The second communication device 140 may transmit, based on an execution command for the at least one of the second program and the third program being received from the user device 300, the execution command for the at least one of the second program and the third program to the second controller 160.

Other components of the second communication device 140 may be the same as those of the second communication device 140 according to an embodiment, and therefore, descriptions thereof will be omitted.

A case in which the third program has not been installed in the second controller 160 will be described.

According to request information for identification information of the display apparatus 100 being received from the user device 300, the second controller 160 may transmit the identification information of the display apparatus to the user device 300.

According to an execution command for the second program or a display command for a second test image being received from the user device 300, the second controller 160 may control the display panel 120 to display the second test image.

According to a corrected overdrive table being received from the user device 300, the second controller 160 may update an overdrive table stored in the second memory by using the received overdrive table.

A case in which a third program has been installed in the second controller 160 will be described.

The second controller 160 may recognize image quality of an image based on a second analyzed image received from the user device 300.

The second controller 160 may recognize the image quality of the image based on the second analyzed image received in real time from the user device 300. The second controller 160 may analyze the image by using the third program and recognize the image quality based on an analysis result on the image.

The second controller 160 may recognize a change of a plurality of block images through image analysis and identify whether the image quality of the image is in a normal state or in an abnormal state based on the recognized change of the plurality of block images.

The change of the plurality of block images may include a change of a plurality of text images in a plurality of background images.

The image quality of the image may include at least one of afterimages, reverse afterimages, or color fringing. The color fringing may include a state in which a different color from a target color is displayed.

The second controller 160 may recognize the image quality to be in an abnormal state based on at least one of afterimages, reverse afterimages, or color fringing being recognized in the plurality of block images.

The second controller 160 may recognize abnormal state information on a block image in an abnormal state.

In a case where a plurality of block images are in an abnormal state, the analysis apparatus may recognize abnormal state information of each block image which is in the abnormal state.

Based on at least one of afterimages, reverse afterimages, or color fringing being recognized in the plurality of block images, the second controller 160 may correct the overdrive table of the display apparatus.

More specifically, the second controller 160 may recognize a gray value of a background image and a gray value of a text image of the block image which is in the abnormal state, recognize a setting voltage based on the abnormal state information on the block image which is in the abnormal state, the gray value of the background image of the block image which is in the abnormal state, and the gray value of the text image, and correct the recognized setting voltage. This configuration may be the same as that of an embodiment, and therefore, descriptions thereof will be omitted.

The second controller 160 may correct the overdrive table based on image quality.

Whenever the second controller 160 corrects the overdrive table based on image quality, the second controller 160 may transmit the corrected overdrive table to the display apparatus and transmit a display command for a second test image through the corrected overdrive table to the display apparatus.

The second controller 160 may repeatedly perform a process of obtaining, according to display control information for a second test image being received from the display apparatus, a second analyzed image and correcting at least one setting voltage in the overdrive table based on the obtained second analyzed image, until the image quality becomes a normal state.

The second controller 160 may recognize image quality of an image to be in a normal state based on any of afterimages, reverse afterimages, or color fringing being not recognized in the plurality of block images, and complete correction of the overdrive table.

The second controller 160 may transmit a finally corrected overdrive table to the display apparatus.

The second controller 160 may include at least one second processor 161 that controls operations of the display apparatus 100, and at least one second memory 162 that stores programs and data for controlling operations of the display apparatus 100.

The at least second processor 161 may include at least one memory that stores algorithms and data in the form of programs for controlling operations of components in the display apparatus 100, and one or more processor chips or processing cores that perform the above-described operations by using data stored in the at least one memory.

The at least one second processor 161 may process various data and various signals by using instructions, data, programs, and/or software stored in the second memory 162.

The at least one second processor 161 may include one or more of a CPU, a GPU, an APU, a MIC, a DSP, an NPU, a hardware accelerator, or a machine learning accelerator.

Components of the second memory 162 may be the same as those of the second memory shown in FIG. 14, and therefore, detailed descriptions thereof will be omitted.

The user device 300 may transmit an execution command for the second program to the display apparatus 100 or transmit a display command for a second test image to the display apparatus 100.

The user device 300 may include an image sensor for obtaining an image displayed on the display apparatus 100.

That is, the user device 300 may obtain a second test image displayed on the display apparatus as a second analyzed image.

In a case where the third program has not been installed in the user device, the user device 300 may transmit a second analyzed image obtained by the image sensor to the display apparatus 100.

The user device 300 may include a third program. The third program may be a program for analyzing image quality of an image displayed on the display apparatus 100.

Hereinafter, an operation of the user device 300 in a case where the third program has been installed in the user device 300 will be described.

The user device 300 may request the display apparatus 100 to send an overdrive table and, according to the overdrive table being received from the display apparatus 100, the user device 300 may store the received overdrive table.

The user device 300 may identify, based on a second analyzed image obtained by the image sensor, whether image quality of an image displayed on the display apparatus 100 is in a normal state or in an abnormal state.

According to the image quality of the image displayed on the display apparatus being recognized to be in an abnormal state, the user device 300 may recognize a block image which is in an abnormal state.

The user device 300 may recognize whether the block image in the abnormal state is a block image in an abnormal state caused by color fringing, a block image in an abnormal state caused by reverse afterimages, or a block image in an abnormal state caused by afterimages. That is, the user device 300 may recognize abnormal state information on the block image in the abnormal state.

The user device 300 may recognize a gray value of a background image and a gray value of a text image of the recognized block image and correct a setting voltage based on the recognized abnormal state information, the gray value of the background image, and the gray value of the text image.

A configuration for correcting the setting voltage based on the recognized abnormal state information, the gray value of the background image, and the gray value of the text image may be the same as a configuration for correcting the setting voltage based on the recognized abnormal state information, the gray value of the background image, and the gray value of the text image in an embodiment, and therefore, descriptions thereof will be omitted.

The user device 300 may correct the overdrive table received from the display apparatus based on the correction of the setting voltage and transmit the corrected overdrive table to the display apparatus.

The user device 300 may be possessed by a user or placed in a user's home or office.

The user device 300 may be implemented as a computer or mobile terminal capable of accessing an external device through a network.

Here, the computer may include, but is not limited to, for example, a notebook, a desktop, a laptop, a tablet PC, or a slate PC on which a web browser is installed.

The mobile terminal may be, for example, a wireless communication device that ensures portability and mobility, and may include all kinds of handheld-based wireless communication devices, such as Personal Communication System (PCS), Global System for Mobile communications (GSM), Personal Digital Cellular (PDC), Personal Handyphone System (PHS), Personal Digital Assistant (PDA), International Mobile Telecommunication-2000 (IMT-2000), Code Division Multiple Access-2000 (CDMA-2000), W-Code Division Multiple Access (W-CDMA), Wireless Broadband Internet (Wibro) terminals, smart phones, etc., and wearable devices, such as watches, rings, bracelets, anklets, necklaces, glasses, contact lenses, or head-mounted devices (HMDs).

The user device 300 may include a communication module capable of communicating with the display apparatus 100, a user interface for receiving a user input or outputting information to a user, at least one processor for controlling operations of the user device 300, and at least one memory in which a program for controlling the operations of the user device 300 is stored.

In the memory of the user device 300, a program, that is, an application for improving a response speed of the display apparatus 100 may be stored. The application may have been sold in the state of being installed in the user device 300 or may be downloaded from a server (not shown) and installed.

Also, in the memory of the user device 300, a program, that is, an application for controlling the display apparatus 100 may be stored.

A user may access the server (not shown) by executing the application installed on the user device 300 to create a user account, and communicate with the server (not shown) based on the user account logged-in.

The user device 300 may register the display apparatus 100 through the server. For example, when a user operates the display apparatus 100 to connect the display apparatus 100 to the server according to a procedure guided by the application installed on the user device 300, the server may register the display apparatus 100 in the user's account by registering identification information (e.g., serial number or MAC address) of the display apparatus 100 in the user's account.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that can be interpreted by a computer. For example, the computer-readable recording medium may include Read Only Memory (ROM), Random Access Memory (RAM), a magnetic tape, a magnetic disc, a flash memory, an optical data storage device, etc.

So far, the disclosed embodiments have been described with reference to the accompanying drawings. It will be understood by one of ordinary skill in the technical art to which the present disclosure belongs that the present disclosure can be embodied in different forms from the disclosed embodiments without changing the technical spirit and essential features of the present disclosure. Thus, it should be understood that the disclosed embodiments described above are merely for illustrative purposes and not for limitation purposes in all aspects.

1. An analysis apparatus comprising:
a communication device configured to communicate with a display apparatus;
a sensor configured to obtain an image of a test image displayed on the display apparatus; and
a controller configured to:
based on a first image of a first test image obtained by the sensor and a second image of a second test image obtained by the sensor, the first image including a first plurality of gray values displayed on the display apparatus and the second image including a second plurality of gray values displayed on the display apparatus that respectively correspond to, and are different values from, the first plurality of gray values, recognize a plurality of response times respectively corresponding to a time for the first plurality of gray values to change to the second plurality of gray values,
based on a difference between the recognized plurality of response times and a reference response time, identify information corresponding to a modification to an overdrive table of the display apparatus, and
control the communication device to transmit the identified information to the display apparatus such that the overdrive table of the display apparatus is correctable based on the identified information.

2. The analysis apparatus of claim 1, wherein
the controller is further configured to:
recognize identification information of the display apparatus,
recognize an original overdrive table of the display apparatus based on the identification information of the display apparatus, and
apply the information corresponding to a modification to correct the original overdrive table.

3. The analysis apparatus of claim 2, wherein
the controller is further configured to:
recognize at least one response time among the recognized plurality of response times that exceeds the reference response time,
recognize a first gray value among the first plurality of gray values and a second gray value among the second plurality of gray values which respectively correspond to the recognized at least one response time,
recognize a setting voltage of the original overdrive table that corresponds to the first gray value and the second gray value, and
based on to the first gray value being smaller than the second gray value, increase the recognized setting voltage by a first voltage to correct the original overdrive table, or based on the first gray value being greater than the second gray value, decrease the recognized setting voltage by a second voltage to correct the original overdrive table.

4. The analysis apparatus of claim 1, further comprising
an input device,
wherein the controller is further configured to receive the reference response time from the input device.

5. The analysis apparatus of claim 1, wherein
the controller is further configured to:
recognize an average response time of the recognized plurality of response times, and
recognize the reference response time based on the recognized average response time.

6. The analysis apparatus of claim 1, wherein
the sensor is a first sensor,
the identified information correspond to the modification to the overdrive table of the display apparatus is identified first information, and
the analysis apparatus further includes a second sensor configured to obtain an image of a test image displayed on the display apparatus, wherein the controller is further configured to:
based on the recognized plurality of response times being shorter than the reference response time, control the communication device to transmit the identified first information to the display apparatus such that a primary correction of the overdrive table of the display apparatus is performed based on the identified first information,
based on a third image of a third test image displayed on the display apparatus obtained by the second sensor, recognize an image quality of the third image,
based on the recognized image quality, identify second information corresponding to a modification to the overdrive table that has been primarily corrected, and
control the communication device to transmit the identified second information to the display apparatus such that the primarily corrected overdrive table is correctable based on the identified second information.

7. The analysis apparatus of claim 6, wherein
the controller is further configured to:
based on the third image obtained by the second sensor, recognize at least one of afterimages, reverse afterimages, or color fringing,
recognize a block image from which the at least one of afterimages, reverse afterimages, or color fringing is recognized,
recognize a gray value of a background image and a gray value of a text image of the recognized block image,
recognize, in the overdrive table that has been primarily corrected, a setting voltage corresponding to the recognized gray value of the background image and the recognized gray value of the text image,
recognize, in the recognized block image, a ratio of the recognized at least one of afterimages, reverse afterimages, or color fringing with respect to the text image, and
based on the recognized ratio exceeding a reference ratio, identify the second information that includes a modification to the setting voltage of the overdrive table that has been primarily corrected such that the setting voltage of the overdrive table that has been primarily corrected is correctable based on the identified second information.

8. The analysis apparatus of claim 1, wherein
the sensor is a first sensor,
the identified information correspond to the modification to the overdrive table of the display apparatus is identified first information, and
the communication device is further configured to communicate with a user device configured to obtain an image of a test image displayed on the display apparatus, and
the controller is further configured to:
control the communication device to transmit the identified first information to the display apparatus such that a primary correction of the overdrive table of the display apparatus is performed based on the identified first information
based on a third image obtained by the user device, recognize an image quality of the third image,
based on the recognized image quality, identify second information corresponding to a modification to the overdrive table that has been primarily corrected, and
control the communication device to transmit the identified second information to the display apparatus such that the primarily corrected overdrive table is correctable based on the identified second information.

9. A display apparatus comprising:
a communication device configured to communicate with an external device;
a display panel including a liquid crystal portion in which an arrangement of liquid crystal molecules changes in response to a voltage applied to an electrode portion, the display panel configured to display a gray image with at least one gray value among a plurality of gray values according to a change of the arrangement of the liquid crystal molecules;
a memory configured to store an overdrive table including a target voltage corresponding to each gray value of the plurality of gray values and a plurality of setting voltages configured to respectively change each gray value of the plurality gray values from a first gray value to a second gray value; and
a controller configured to:
based on a change of a gray value corresponding to a change of an image displayed through the display panel, recognize a first gray value and a second gray value, changed from the first gray value, from among the plurality of gray values,
recognize a target voltage corresponding to the second gray value,
recognize a setting voltage corresponding to the first gray value and the second gray value from the overdrive table,
control the setting voltage to be applied to the electrode portion, and then control the target voltage to be applied to the electrode portion, and
correct, according to information to correct the overdrive table being received from the external device, the overdrive table stored in the memory.

10. The display apparatus of claim 9, wherein
the controller is further configured to:
based on a command to correct the stored overdrive table received from the external device, control the display panel to display a first image and a second image.

11. The display apparatus of claim 9, wherein
the external device includes an analysis apparatus configured to analyze a response time of liquid crystals of the display panel and analyze image quality of an image on the display panel, a user device configured to obtain an image on the display panel, or a combination thereof.

12. A control method of an analysis apparatus including a communication device configured to communicate with a display apparatus, a sensor configured to obtain an image of a test image displayed on the display apparatus, and a controller, the control method comprising:
by the controller,
identifying identification information of a display apparatus;
recognizing an original overdrive table of the display apparatus based on the identification information of the display apparatus;
obtaining, by the sensor, a first image of a first test image displayed on the display apparatus and a second image of a second test image displayed on the display apparatus, the first image including a first plurality of gray values displayed on the display apparatus and the second image including a second plurality of gray values displayed on the display apparatus that respectively correspond to, and are different values from, the first plurality of gray values;
based on the obtained first image and the obtained second image, recognizing a plurality of response times respectively corresponding to a time for the first plurality of gray values to change to the second plurality of gray values;
based on a difference between the recognized plurality of response times and a reference response time, identifying information corresponding to a modification to the original overdrive table of the display apparatus; and
transmitting the identified information to the display apparatus such that the original overdrive table of the display apparatus is correctable based on the identified information.

13. The control method of claim 12, wherein
a correction of the original overdrive table of the display apparatus includes:
by the controller,
recognizing at least one response time among the recognized plurality of response times that exceeds the reference response time,
recognizing a first gray value among the first plurality of gray values and a second gray value among the second plurality of gray values which respectively correspond to the recognized at least one response time,
recognizing a setting voltage of the original overdrive table that corresponds to the first gray value and the second gray value, and
based on to the first gray value being smaller than the second gray value, increasing the recognized setting voltage by a first voltage to correct the original overdrive table, or based on the first gray value being greater than the second gray value, decreasing the recognized setting voltage by a second voltage to correct the original overdrive table.

14. The control method of claim 12, wherein
the sensor is a first sensor,
the identified information correspond to the modification to the overdrive table of the display apparatus is identified first information, and
the analysis apparatus further includes a second sensor configured to obtain an image of a test image displayed on the display apparatus, and
the method further includes:
by the controller,
based on the recognized plurality of response times being shorter than or equal to the reference response time, control the communication device to transmit the identified first information to the display apparatus such that a primary correction of the overdrive table of the display apparatus is performed based on the identified first information,
obtaining, by the second sensor, a third image of a third test image displayed on the display apparatus,
recognizing an image quality of the third image,
based on the recognized image quality, identify second information corresponding to a modification to the original overdrive table that has been primarily corrected, and
transmitting the identified second information to the display apparatus such that the primarily corrected overdrive table is correctable based on the identified second information.

15. The control method of claim 14, wherein
a correction of the primarily corrected overdrive table based on the recognized image quality includes:
based on the third image obtained by the second sensor, recognizing at least one of afterimages, reverse afterimages, or color fringing,
recognizing a block image from which the at least one of afterimages, reverse afterimages, or color fringing is recognized,
recognizing a gray value of a background image and a gray value of a text image of the recognized block image,
recognizing, in the overdrive table that has been primarily corrected, a setting voltage corresponding to the recognized gray value of the background image and the recognized gray value of the text image,
recognizing, in the recognized block image, a ratio of the recognized at least one of afterimages, reverse afterimages, or color fringing with respect to the text image, and
based on the recognized ratio exceeding a reference ratio, identifying the second information that includes a modification to the setting voltage of the overdrive table that has been primarily corrected such that the setting voltage of the overdrive table that has been primarily corrected is correctable based on identified second information.
